(19) United States
(12) Patent Application Publication
(10) Pub. No.: US 2007/0081441 A1
(43) Pub. Date: Apr. 12, 2007

(54) Optical pickup device and information recording/reproducing apparatus

(75) Inventor: Taizoh Yokota, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/546,132

(22) Filed: Oct. 10, 2006

(30) Foreign Application Priority Data
Oct. 11, 2005 (JP) JP2005-296925

(51) Int. Cl. G11B 7/135

(52) U.S. Cl. 369/112.16

(57) ABSTRACT

An optical pickup device according to the present invention having two light sources is capable of emitting lights having different wavelengths from each other for recording/reproducing information on/from an optical recording medium by using a light from the light source; wherein the two light sources both are capable of emitting either polarization lights in one polarization direction or polarization lights perpendicular to the one polarization direction, and each of the two light sources is arranged at a predetermined position depending on a polarization direction of the light to be emitted.

This Nonprovisional application claims priority under 35 U.S.C. §119(a) on Patent Application No.2005-296925 filed in Japan on Oct. 11, 2005, the entire contents of which are hereby incorporated by reference.

### BACKGROUND OF THE INVENTION

1. Field of the Invention

The present invention relates to: an optical pickup device used to optically record/reproduce information on/from a disk-shaped optical recording medium (hereinafter, referred to as “optical disk”); and an information recording/reproducing apparatus using the optical pickup device.

2. Description of the Related Art

In the optical pickup device of this kind, as an optical pickup device which is capable of handling a plurality of wavelengths, the following elements are provided; (i) a plurality (two or more) of semiconductor laser elements having different light source wavelengths from each other and (ii) a light receiving element for receiving a reflection light reflected from an optical disk after a laser light is irradiated from any one of the plurality of semiconductor laser elements in order to handle optical disks which have different specifications from each other (e.g., DVD (Digital Video Disk), CD (Compact Disk), BD (Blu-ray Disk), etc).

Owing to this, the laser light emitted from one of the semiconductor laser elements is irradiated onto an information recording plane of the optical disk, and the reflection light reflected on the information recording plane of the optical disk is received by the light receiving element so as to detect an output signal. Based on the detected output signal, it is possible to reproduce the information recorded on the optical disk.

For example, an optical pickup device capable of handling two wavelengths is known in which two different optical pickup devices are incorporated as one optical pickup device in order to handle the specification of two types of optical disks.

Furthermore, References 1 to 4 disclose an optical pickup device capable of handling two wavelengths in which two semiconductor laser elements having wavelengths of laser lights different from each other are incorporated into one optical pickup device. In the optical pickup device capable of handling two wavelengths, the polarization direction of the laser lights having two types of wavelengths is changed by 90 degrees by a ½ wavelength plate. Thereafter, the laser lights are incident on a polarization beam splitter (hereinafter, referred to as “PBS”), and then optical paths of the laser lights are combined. Hereinafter, the optical pickup device capable of handling two wavelengths will be described in detail with reference to FIG. 10.

FIG. 10 is a perspective view showing a structural example of important parts of a conventional optical pickup device capable of handling two wavelengths.

In FIG. 10, the conventional optical pickup device 100 capable of handling two wavelengths includes a semiconductor laser element 1 for DVD which has a relatively short-wavelength, a semiconductor laser element 2 for CD which has a relatively long-wavelength, first and second PBSs 3 and 4 on which laser lights are incident, respectively, and a light receiving element 5 for receiving a reflection light and converting the reflection light into a signal electric charge.

On the side opposite to an optical disk 6 with respect to the first PBS 3, a cylindrical lens 7 is provided in order to produce astigmatism used for detecting a focus error. On the side opposite to the semiconductor laser element 2 with respect to the second PBS 4, alight receiving element 8 for power control is provided in order to detect a laser power and adjust an output of the laser light.

Furthermore, along the optical path from the second PBS 4 to an optical disk 6, a ¼ wavelength plate 9 for changing an optical phase by π/4, a collimate lens 10 for collimating the light from the ¼ wavelength plate 9 into a collimate light, a raise mirror 11 for bending the optical path of the light by 90 degrees and an objective lens 12 for focusing the light onto the plane of the optical disk 6 are provided in this order. An actuator drum 13 and an actuator supporting body 14 for supporting the actuator drum 13 are provided in order to adjust the position of the objective lens 12.

Furthermore, between the first PBS 3 and the semiconductor laser element 1, a ½ wavelength plate 15 for changing the polarization direction of the light by 90 degrees and a three-beam grating 16 for forming two sub-beams, which are used for detecting a tracking error, in addition to a main-beam are provided in this order. Between the second PBS 4 and the semiconductor laser element 2, a ½ wavelength plate 17 for changing the polarization direction of the light by 90 degrees and a three-beam grating 18 for forming two sub-beams, which are used for detecting a tracking error, in addition to a main-beam are provided in this order. The ½ wavelength plates 15 and 17 respectively change the polarization direction of the laser lights by 90 degrees, in which P polarized lights emitted from the semiconductor laser elements 1 and 2 are respectively changed into S polarized lights, in order to reflect the laser lights, which are incident on the first PBS 3 and the second PBS 4, respectively, on each inclined plane (mirror plane) of the first PBS 3 and the second PBS 4.

FIG. 11 is a schematic view for explaining the polarization direction of the laser light in an optical system in the optical pickup device 100 capable of handling two wavelengths shown in FIG. 10. FIG. 11(a) is a view showing a light emission path from the semiconductor laser elements 1 and 2 to the optical disk 6. FIG. 11(b) is a view showing a light receiving path from the optical disk 6 to the light receiving element 5. In FIG. 11, arrows represent the P polarized light parallel to the surface of the figure, and double circles represent the S polarized light perpendicular to the surface of the figure.

As shown in FIG. 11(a), the P polarized laser light emitted from the semiconductor laser element 1 is divided into three beams by the three-beam grating 16 shown in FIG. 10 and then rotated into the S polarized light by the ½ wavelength plate 15. This S polarized light is reflected on the inclined plane of the first PBS 3, transmitted through the inclined plane of the second PBS 4 and then converted into a circularly polarized light q1 by the ¼ wavelength plate 9. The circularly polarized light q1 is right-handed clockwise direction with respect to its propagating direction. Concurrently, a portion of the light is reflected on the inclined plane of the second PBS 4 and then incident on the light receiving element 8 for power control.

In contrast, the P polarized laser light emitted from the semiconductor laser element 2 is divided into three beams by the three-beam grating 18 and then rotated into the S polarized light by the ½ wavelength plate 17. This S polarized light is reflected on the inclined plane of the second PBS 4 and then converted into a circularly polarized light q1 by the ¼ wavelength plate 9. The circularly polarized light q1 is right-handed clockwise direction with respect to its propagating direction. Concurrently, a portion of the light is transmitted through the inclined plane of the second PBS 4 and then incident on the light receiving element 8 for power control.

The circularly polarized light q1 in the right-handed clockwise direction from the ¼ wavelength plate 9 is collimated into a collimate light by the collimate lens 10, reflected by the raise mirror 11, and the propagating direction of the light is bent by 90 degrees. The circularly polarized light q1 is converted into a circularly polarized light q2, which is left-handed anti-clockwise direction with respect to its propagating direction, and focused onto the information recording plane of the optical disk 6 by the objective lens 12.

As shown in FIG. 11(b), the direction of the circularly polarized light of the reflection light reflected from the optical disk 6 is opposite to that shown in FIG. 11(a), and the reflection light is converted into the P polarized light by the ¼ wavelength plate 9 after propagating through the objective lens 12, the raise mirror 11 and the collimate lens 10. This P polarized light is transmitted through each inclined plane of the second PBS 4 and the first PBS 3 and then incident on the light receiving element 5 through the cylindrical lens 7.

As described above, the P polarized lights from the semiconductor laser elements 1 and 2 are rotated into the S polarized lights by the ½ wavelength plates 15 and 17, respectively, reflected by each inclined plane of the first PBS 3 and the second PBS 4 and then combined into the same optical path.

Furthermore, in order to miniaturize the optical pickup device, References 4 and 5 disclose, for example, an optical pickup device in which outputs of the light receiving element are internally connected, which is shown in FIG. 12.

FIG. 12 is a circuit diagram showing a state of terminal connection of the light receiving element in the conventional optical pickup device disclosed in References 4 and 5.

In FIG. 12, the light receiving element 5 includes a main-beam light receiving area 5a for detecting a focus error and sub-beam light receiving areas 5b and 5c for detecting a tracking error. When each of the four-divided light receiving areas is described, the top-to-bottom direction (longitudinal direction) in FIG. 12 corresponds to the outer circumferential side and the inner circumferential side of the optical disk. The upper side corresponds to the outer circumferential side of the optical disk and the lower side corresponds to the inner circumferential side of the optical disk. Furthermore, the left-to-right direction (lateral direction) in FIG. 12 corresponds to the front side and the rear side of the optical disk. The left side corresponds to the front side of a light receiving spot and the right side corresponds to the rear side of the light receiving spot. For example, in the main-beam 5a, the areas A, B, C, D respectively correspond to signal outputs of the front outer circumferential side, the front inner circumferential side, the rear inner circumferential side, and the rear outer circumferential side of the optical disk.

For example, as described in FIG. 11(b), the astigmatism is given to each light flux by the cylindrical lens 7 in order to detect the focus error. The main-beam light receiving area 5a is divided into four areas (A to D). When the signal output from each of the areas A to D satisfies

FES (focus error signal)=(A+C)−(B+D)=0, the main-beam light receiving area 5a is determined to be in a focus state. Otherwise, the main-beam light receiving area 5a is determined to be out of the focus state, thereby the focus error signal being detected. For this reason, a signal output terminal is provided to each of four areas.

Additionally, as shown, for example, in Reference 4, each of the light fluxes is divided into one main-beam and two sub-beams by the three-beam gratings 16 and 18 shown in FIG. 10, respectively, in order to detect the tracking error. Each light receiving area 5b and 5c of the two sub-beams is divided into four-divided areas E1 to E4 and F1 to F4, respectively. Herein, the four-divided areas E1 and F1 represent the front outer circumferential side of the optical disk, the four-divided areas E2 and F2 represent the front inner circumferential side of the optical disk, the four-divided areas E3 and F3 represent the rear inner circumferential side of the optical disk, and the four-divided areas E4 and F4 represent the rear outer circumferential side of the optical disk. In detecting the tracking error, when the signal output from each of the four-divided areas is
(E1+F1)+(E2+F2)=(E3+F3)+(E4+F4),
and
(E1+F1)+(E4+F4)=(E2+F2)+(E3+F3),
it is determined that there is no relative rotation error or no pitch error between the two sub-beams (or the three beams and the light receiving element 5).

As shown in FIG. 12, it is commonly practiced to reduce the number of output terminals by connecting the four-divided areas E1 and F1, the four-divided areas E2 and F2, the four-divided areas E3 and F3 and the four-divided areas E4 and F4, respectively, for output, wherein both four-divided areas of each pairing have the same in-phase positional relationship, in the light receiving element 5. This is considered to be an advantage of an apparent uniform output, the reduction of the number of terminals, the miniaturization and the cost reduction of the device.

[Reference 1] Japanese Laid-Open Publication No. 4-82030
[Reference 2] Japanese Laid-Open Publication No. 2005-85334
[Reference 3] Japanese Laid-Open Publication No. 2002-63730
[Reference 4] Japanese Laid-Open Publication No. 2000-82226
[Reference 5] Japanese Laid-Open Publication No. 7-272303

### SUMMARY OF THE INVENTION

As described above, in order to handle optical disks having specifications different from each other by using one optical pickup device, it is necessary to use two different optical pickup devices, or incorporate two semiconductor laser elements, having laser lights of different wavelengths from each other, into one optical pickup device. For this, as shown in FIGS. 10 and 11, after changing the polarization direction of the laser lights, which are emitted from the semiconductor laser elements 1 and 2, by using the ½ wavelength plates 15 and 17 having crystallinity, two types of wavelength lights are incident on the first PBS 3 and the second PBS 4, respectively.

However, the use of the ½ wavelength plates 15 and 17 arises a problem of increasing the size and cost of the optical pickup device. Recently, as optical disk devices have become thinner, further thinning (ultra-thinning) optical pickup devices is being requested from the market. Also, along with the popularization of the optical disk devices, the cost reduction of the optical disk devices is being requested as well. As a result, the use of many parts in an optical pickup device leads to the cost increase of the device and the man hour increase for assembly work as well as leading to increasing the size of the device. As described above, there is a problem that the conventional pickup device capable of handling two wavelengths cannot meet the request from the market in view of the cost and assembly of the device.

Furthermore, special computer-reading recording medium (e.g., DVD-R and DVD-RAM) capable of recording information on lands and grooves are proposed. Thus, it is becoming difficult to secure the playability of the optical pickup device. This problem will be described below.

FIG. 13 is a schematic view for explaining a DVD-RAM optical disk. FIG. 13(a) is a perspective view showing important parts of the optical pickup device for the optical disk for explaining a land portion of the optical disk. FIG. 13(b) is a view showing an image of a land portion; and a state of a light receiving spot on a light receiving element when a light including a diffraction pattern is reflected at the land portion of the optical disk. FIG. 13(c) is a perspective view showing important parts of the optical pickup device for the optical disk for explaining a groove portion of the optical disk. FIG. 13(d) is a view showing an image of a groove portion; and a state of a light receiving spot on a light receiving element when a light including a diffraction pattern is reflected at the groove portion of the optical disk. In order to simplify the description thereof, FIGS. 13(a) and (c) only show a land R and a groove G, respectively, the objective lens 12, the collimate lens 10, the cylindrical lens 7 and the main-beam light receiving area 5a for detecting the focus error in the light receiving element 5.

As shown in FIG. 13(b), the land R is a convex portion of the optical disk 6. As shown in FIG. 13(d), the groove G is a concave portion of the optical disk 6. Thus, the light-dark in the diffraction pattern of the light which is reflected on the land R and the groove G, respectively, is reversed.

First, a case which does not have any problem will be described. In other words, as shown in FIG. 14(a), the case will be described, in which there is no relative rotation error between a light receiving spot H and four-dividing lines m and n of the light receiving element, and the diffraction pattern and the four-dividing lines m and n are positioned so as to be symmetrical to each other with respect to a horizontal direction and a vertical direction.

As described above, the astigmatism is given to each light flux by the cylindrical lens 7, and the main-beam light receiving area Sa for detecting a focus error signal is divided into four areas (A to D) in order to detect the focus error. When the signal output from each of the areas A to D satisfies
FES=(A+C)−(B+D)=0,
the main-beam light receiving area 5a is determined to be in a focus state. Otherwise, the main-beam light receiving area 5a is determined to be out of the focus state, thereby the focus error signal being detected.

As shown in FIG. 14(a), in the case in which there is no relative rotation error, and the light receiving element and a detecting lens represented by the cylindrical lens 7 have an equivalent focus state relationship to that of the land R of the optical disk, and then when the position is adjusted to
FES (land)=(A+C)−(B+D)=0,
the focus state exists in the land portion R.

Additionally, as shown in FIG. 14(b), and also in the case when the tracking is switched from the land R to the groove G,
FES (groove)=(A+C)−(B+D)=0
is established, and the signal output from each of the areas A to D satisfies the relationship of the value of FES (groove) being 0. Thus, there is no occurrence of focus difference between the land R and the groove G. For example, in a DVD-RAM disk, when the light receiving spot H is not inclined relative to the pattern of the light receiving element 5, there is no occurrence of a defocus difference in the groove G of a DVD-RAM disk even if a defocus adjustment is performed on the land R of the DVD-R disk or DVD-RAM disk.

On the other hand, in the case in which there is a problem, if there is an occurrence of an error when the cylindrical lens 7 is manufactured or a rotation error when the light receiving element 5 is attached, as shown in FIG. 15(a), there is a case in which the light receiving spot H and the four-dividing lines m and n of the light receiving element 5 are not line-symmetrical to each other due to the occurrence of the rotation error. As described above, in a state where the light receiving spot has the rotation error, and when the focus state is adjusted including light-dark areas of by the diffraction pattern, as shown in FIG. 15(b), the following adjustment:
FES (land)=(A+C)−(B+D)=0
is performed by deforming the beam into a slightly elliptical shape rather than into a perfectly circular shape. While in this state, if the tracking is switched to the groove G,
FES (groove)=(A+C)−(B+D)<0
is established as shown in FIG. 15(c). Thus, a problem occurs that the focus state at each of the land R and the groove G does not coincide with each other.

Furthermore, even for the structure in which outputs of the light receiving element 5 are internally connected in order to miniaturize the optical pickup device, the error can not be absorbed when the tracking error is adjusted and is a cause for reducing the reproduction performance. The problem of reducing the reproduction performance will be described below.

As shown in FIG. 12, in the structure in which output is produced by internally connecting the four-divided areas E1 and F1, the four-divided areas E2 and F2, the four-divided areas E3 and F3 and the four-divided areas E4 and F4, respectively, wherein both four-divided areas of each pairing have the same in-phase positional relationship, it is not possible to detect the positional relationship of the light receiving spot H relative to the sub-beams of the light receiving element 5 from the output of the sub-beam. As a result, the relative rotation error between the sub-beam and the light receiving element 5 and the pitch error of the sub-beam which is incident on the light receiving element 5 are offset. For example, even if a relative positional error exists between the sub-beam and the light receiving element 5, the following output;
(E1+F1)=(E2+F2)=(E3+F3)=(E4+F4)
can be obtained. Thus, the positional error cannot be detected by using the above expression.

When such a relative rotation error between the sub-beam and the light receiving element 5 or such a pitch error of the sub-beam which is incident on the light receiving element 5 occurs, asymmetry occurs in an astigmatic output of a sub-beam in the differential astigmatic focus error detection. As a result, a problem that the interference between tracks cannot be suppressed occurs. Furthermore, a problem occurs that the offset of the tracking error signal is changed between the tracks of the recorded section and the tracks of the unrecorded section in DPP (Differential Push-Pull) method due to the pitch error of the sub-beam and thus a servo control of the optical pickup device becomes unstable.

The present invention solves the conventional problems described above. The objective of the present invention is to provide: an optical pickup device which is capable of handling two types of laser wavelengths, which can be miniaturized by reducing the number of components, which stably performs a precision adjustment by adjusting a focus error and a tracking error, and which can be applied to a DVD-RAM and the like; and an information recording/reproducing apparatus using the optical pickup device.

An optical pickup device according to the present invention having two light sources is capable of emitting lights having different wavelengths from each other for recording/reproducing information on/from an optical recording medium by using a light from the light source; wherein the two light sources both are capable of emitting either polarization lights in one polarization direction or polarization lights crossing to the one polarization direction, and each of the two light sources is arranged at a predetermined position depending on a polarization direction of the light to be emitted, thereby the objective described above being achieved.

Preferably, an optical pickup device according to the present invention further includes: a first beam splitter, arranged farther from the optical recording medium, for causing the lights having different wavelengths to be incident from different directions, for reflecting one of the lights on an inclined plane of the first beam splitter and for transmitting the other of the lights through the inclined plane of the first beam splitter so as to emit both lights in the same direction; second beam splitter, arranged closer to the optical recording medium, for transmitting the light from the first beam splitter through an inclined plane of the second beam splitter and irradiating the light onto the optical recording medium and for reflecting a reflection light from the optical recording medium on the inclined plane of the second beam splitter so as to emit the reflection light; and a light receiving element for receiving an emission light from the second beam splitter.

Furthermore, preferably, an optical pickup device according to the present invention further includes: a first beam splitter, arranged farther from the optical recording medium, for causing the other of the lights having different wavelengths from each other to be incident on the first beam splitter and reflecting the other of the lights on an inclined plane of the first beam splitter; a second beam splitter, arranged closer to the optical recording medium, for transmitting the light from the first beam splitter through an inclined plane of the second beam splitter and for causing one of the lights having different wavelengths from each other to be incident on the second beam splitter and reflecting the one of the lights on the inclined plane of the second beam splitter and irradiating the light onto the optical recording medium and for transmitting a reflection light from the optical recording medium through the inclined plane of the second beam splitter; and a light receiving element for receiving the light from the first beam splitter, the light from the second beam splitter being transmitted through the inclined plane of the first beam splitter.

An optical pickup device according to the present invention includes: two light sources capable of emitting lights having different wavelengths, respectively; a first beam splitter, arranged farther from the optical recording medium, for causing the lights having different wavelengths to be incident from different directions, for reflecting one of the lights on an inclined plane of the first beam splitter and for transmitting the other of the lights through the inclined plane of the first beam splitter and emitting the both lights in the same direction; a second beam splitter, arranged closer to the optical recording medium, for transmitting the light from the first beam splitter through an inclined plane of the second beam splitter and irradiating the light onto the optical recording medium and for reflecting a reflection light from the optical recording medium on the inclined plane of the second beam splitter so as to emit the reflection light; and a light receiving element for receiving an emission light from the second beam splitter, thereby the objective described above being achieved.

Preferably, in an optical pickup device according to the present invention, the first beam splitter is structured so as to transmit, among the lights having different wavelengths, the light having a longer wavelength through the inclined plane of the first beam splitter and reflects the light having a shorter wavelength on the inclined plane of the first beam splitter.

Furthermore, preferably, in an optical pickup device according to the present invention, a light receiving element for power control is arranged on a side opposite to the side where one of the two light sources for the first beam splitter are arranged and facing a side different from a light emission side of the first splitter, the light receiving element for detecting a light output power from the two light sources and for performing an output adjustment, and among the lights having different wavelengths, a portion of the one of lights is transmitted through the inclined plane of the first beam splitter and a portion of the other of the lights is reflected on the inclined plane of the first beam splitter so as to guide the portions to the light receiving element for power control.

Furthermore, preferably, in an optical pickup device according to the present invention, among the lights having different wavelengths, a portion of the light having a shorter wavelength as the one of the lights is transmitted through the inclined plane of the first beam splitter and a portion of the light having a longer wavelength as the other of the lights is reflected on the inclined plane of the first beam splitter so as to guide the portions to the light receiving element for power control.

Furthermore, preferably, in an optical pickup device according to the present invention, a light receiving element for power control is arranged facing a side opposite to the side where the light receiving element for the second beam splitter is arranged, the light receiving element for power control for detecting a light output power from the two light sources and for performing an output adjustment, and portions of both of the lights having different wavelengths from each other are reflected on the inclined plane of the second beam splitter so as to guide to the light receiving element for power control.

Furthermore, preferably, an optical pickup device according to the present invention further includes: a raise mirror, provided on a light emission side of the second beam splitter, for bending an optical path by 90 degrees.

Furthermore, preferably, in an optical pickup device according to present invention, two light sources are both semiconductor laser elements and P polarized laser lights from the semiconductor laser elements can be incident on the first beam splitter.

Furthermore, preferably, an optical pickup device according to present invention further includes: between the second beam splitter and the light receiving element, a cylindrical lens for generating astigmatism used for detecting a focus error; a cylindrical lens adjusting section for rotation-adjusting the cylindrical lens with the optical axis as its center.

An optical pickup device according to the present invention includes: two light sources capable of emitting lights having different wavelengths from each other, respectively; a first beam splitter, arranged farther from an optical recording medium, for causing the other of the lights having different wavelengths from each other to be incident on the first beam splitter and reflecting the other of the lights on an inclined plane of the first beam splitter; a second beam splitter, arranged closer to the optical recording medium, for transmitting the light from the first beam splitter through an inclined plane of the second beam splitter and for causing one of the lights having different wavelengths from each other to be incident on the second beam splitter and reflecting the one of the lights on the inclined plane of the second beam splitter and irradiating the light onto the optical recording medium and for transmitting a reflection light from the optical recording medium through the inclined plane of the second beam splitter; and a light receiving element for receiving the light emitted from the first beam splitter, the light from the second beam splitter being transmitted through the inclined plane of the first beam splitter, thereby the objective described above being achieved.

Preferably, in an optical pickup device according to the present invention, an emission light from the second beam splitter is irradiated onto the optical recording medium directly through an objective lens.

Furthermore, preferably, in an optical pickup device according to the present invention, the first beam splitter is structured with a flat plate.

Furthermore, preferably, in an optical pickup device according to the present invention, a light receiving element for power control is arranged facing a side opposite to the side where one of two light sources for the second beam splitter is arranged, the light receiving element for power control for detecting a light output power from the light source and for performing an output adjustment, and among the lights having different wavelengths, a portion of the one of lights is transmitted through the inclined plane of the second beam splitter and a portion of the other of the lights is reflected on the inclined plane of the second beam splitter so as to guide the portions to the light receiving element for power control.

Furthermore, preferably, in an optical pickup device according to the present invention, a ¼ wavelength plate is attached to a light emission side of the second beam splitter.

Furthermore, preferably, an optical pickup device according to the present invention further includes an objective lens and an actuator for driving the objective lens, the objective lens and the actuator being arranged on the light emission side of the second beam splitter, and wherein the second beam splitter and the ¼ wavelength plate are integrated and at least a portion thereof is placed in a drum of the actuator.

Furthermore, preferably, an optical pickup device according to the present invention further includes a light receiving element for power control facing a side opposite to the side where one of two light sources for the second beam splitter is arranged, the light receiving element for power control for detecting a light output power from the light source and for performing an output adjustment; and an objective lens and an actuator for driving the objective lens, the objective lens and the actuator being arranged on the light emission side of the second beam splitter, and wherein the second beam splitter, the ¼ wavelength plate and the light receiving element for power control are integrated and at least a portion thereof is placed in a drum of the actuator.

Furthermore, preferably, in an optical pickup device according to the present invention, a semi-circular part or a circular part of the actuator drum is taken out such that that the actuator drum does not block an optical path of the light from the light source.

Furthermore, preferably, in an optical pickup device according to the present invention, the two light sources are both semiconductor laser elements and S polarized laser lights from the semiconductor laser elements can be directly incident on the second beam splitter and the first beam splitter, respectively.

Furthermore, preferably, an optical pickup device according to the present invention further includes: between the first beam splitter and the light receiving element, a cylindrical lens for generating astigmatism used for detecting a focus error; and a cylindrical lens adjusting section for rotation-adjusting the cylindrical lens with the optical axis as its center.

Furthermore, preferably, an optical pickup device according to the present invention includes two four-divided sub-beam light receiving areas for detecting a tracking error in the light receiving element, and further includes: in-phase connections and relative-connections for connecting outputs of the front inner circumferential sides, outputs of the rear inner circumferential sides, outputs of the front outer circumferential sides and outputs of the rear outer circumferential sides of the forward sub-beam and the rearward sub-beam, the outputs of the respective sides having the same in-phase positional relationship and having the symmetrical positional relationship, respectively, in the two sub-beams; and a switching section for switching between outputs from the in-phase connections and outputs from the relative connections.

Furthermore, preferably, an optical pickup device according to the present invention includes: two four-divided sub-beam light receiving areas for detecting a tracking error in the light receiving element, wherein the optical pickup device is capable of connecting outputs of the front inner circumferential sides, outputs of the rear inner circumferential sides, outputs of the front outer circumferential sides and outputs of the rear outer circumferential sides of a forward sub-beam and a rearward sub-beam and of producing an output, wherein the outputs of the respective sides have the same in-phase positional relationship.

Furthermore, preferably, an optical pickup device according to the present invention includes: in-phase connections and relative-connections for connecting outputs of the front inner circumferential sides, outputs of the rear inner circumferential sides, outputs of the front outer circumferential sides and outputs of the rear outer circumferential sides of the forward sub-beam and the rearward sub-beam, the outputs of the respective sides having the same in-phase positional relationship and having the symmetrical positional relationship, respectively, in the two sub-beams; and a switching section for switching between outputs from the in-phase connections and outputs from the relative connections.

Furthermore, preferably, an optical pickup device according to the present invention further includes: a grating section, arranged facing the light emission side of each of the two light sources, for forming a sub-beam used for detecting a tracking error; and a grating adjustment section capable of movement-adjusting the grating section in the direction of the optical axis.

Furthermore, preferably, an optical pickup device according to the present invention further includes a grating section, arranged facing the light emission side of each of the two light sources, for forming a sub-beam used for detecting a tracking error.

Furthermore, preferably, an optical pickup device according to the present invention further includes a grating adjustment section capable of movement-adjusting the grating section in the direction of the optical axis.

An information recording/reproducing apparatus according to the present invention for recording/reproducing information on/from the optical recording medium by using the optical pickup device described above according to the present invention, thereby the objective described above being achieved.

Owing to the structure described above, hereinafter, the function of the present invention will be described.

The present invention has a characteristic structure in that it includes two light sources for emitting lights (e.g., laser lights) having different wavelengths from each other, the two light sources both emit either polarized lights in one polarization direction or polarized lights in a direction perpendicular to the one polarization direction (e.g., P polarized light or S polarized light), and each of the light sources is arranged at a predetermined position in accordance with the polarization direction of the respective emitted laser lights.

Two types of laser lights having different wavelengths from each other are incident on the first PBS, which is arranged farther from the optical recording medium (optical disk), from different directions from each other, both of them as P polarized lights. In accordance with each of the wavelengths, one of them is reflected on the inclined plane (mirror plane) of the first PBS and the other is transmitted through the inclined plane of the first PBS and then combined into the same optical path. For example, the laser light having the longer wavelength (the other) can be transmitted through the inclined plane of the first PBS, and the laser light having the shorter wavelength (the one) can be reflected on the inclined plane of the first PBS.

The P polarized laser light emitted from the first PBS is transmitted through the inclined plane of the second PBS, which is arranged closer to the optical recording medium, and irradiated onto the optical recording medium. An S polarized light component which is a reflection light reflected from the optical recording medium is reflected on the inclined plane of the second PBS and guided to the light receiving element side.

Owing to this, the present invention is capable of causing two type of laser lights having different wavelengths from each other to be incident on the PBS (Beam Splitter) and combining the optical paths of the laser lights, without changing the polarization direction of the light, which is incident on the PBS by using a ½ wavelength plate as performed in the conventional optical pickup device. Therefore, it is possible to construct a compact optical pickup device at a low cost by reducing the number of the components for the optical pickup device. Furthermore, a return light is reflected by the second PBS, which is arranged closer to the optical recording medium, depending on the polarization direction of the return light. Thus, almost no light returns to the first PBS side, thereby being able to suppress the noise occurrence by the return light to the semiconductor laser element as a light source and enhance the reliability of the optical pickup device.

Furthermore, it is possible to adjust the light output from the semiconductor laser elements by providing a light receiving element for power control on the first PBS side or the second PBS side and detecting portions of the laser lights. For example, several percentage to dozens of percentage of the laser light having the longer wavelength of the laser lights having two wavelengths different from each other is reflected on the inclined plane of the first PBS, and several percentage to dozens of percentage of the laser light having the shorter wavelength of the laser lights having two wavelengths different from each other is transmitted through the inclined plane of the first PBS. They are guided to the light receiving element for power control. Therefore, it is possible to utilize the loss of the laser lights in the first PBS for power control, thereby being able to perform an efficient power distribution. Furthermore, for the light flux propagating toward the optical recording medium after being transmitted through or being reflected on the first PBS, it is possible to reflect a portion of the light flux propagating through the second PBS and to guide it to the light receiving element for power control. Since it is possible to have a structure in which the light receiving element for power control can be provided on either the first PBS side or the second PBS side, the freedom of setting the reflection and transmission coefficients of the PBS which depend on the wavelengths and the polarization directions of the lights increases. Thus, it is possible to construct a stable optical pickup device at a low cost.

Furthermore, by attaching a ¼ wavelength plate to the light emission side of the second PBS, it is possible to miniaturize the optical pickup device with the reduction of the area of the ¼ wavelength plate. Furthermore, it is possible to reduce the amount of the rotation error which occurs when the ¼ wavelength plate is attached to the second PBS and to enhance the reliability of the optical pickup device. Furthermore, since the distance between the ¼ wavelength plate and the second PBS becomes shorter, the freedom of selecting a focusing distance of the collimate lens can increase, thereby being able to enhance the reliability of the device.

Furthermore, it is possible to freely set an optical path length by providing a raise mirror for bending the optical path by 90 degrees in the light emission side of the second PBS. Thus, it is possible to select the optical path length which can avoid the laser noise and fabricate a compact thin light pickup device with stable accuracy.

Furthermore, since astigmatism, which is used in a commonly-used focus error detection method, is generated, in a cylindrical lens arranged facing the light incidence side of the light receiving element, the rotation error of a light receiving spot with respect to dividing lines (four-dividing lines) of the light receiving element may occur due to (i) the rotation error of the light receiving element resulting from the design and manufacturing error of the cylindrical lens and (ii) the rotation error which is caused at the time of mounting the light receiving element. As a result, the diffraction pattern of a push-pull signal which crosses the tracks of the optical recording medium includes an angle error with respect to the dividing lines of the light receiving element. Therefore, an accurate push-pull diffraction signal cannot be obtained. By rotation-adjusting, performed by a structure capable of rotation-adjustment, the cylindrical lens with the optical axis as its center, it is possible that the light of the diffraction pattern of a push-pull signal, which crosses the tracks of the optical recording medium, is accurately received with respect to the dividing lines of the light receiving element. Thus, it is possible to generate a stable tracking error signal and focus error signal.

Furthermore, in the four-divided sub-beam light receiving areas, which are provided in order to detect the tracking error, it is commonly practiced to reduce the number of the output terminals by respectively connecting the outputs of the front inner circumferential sides, the outputs of the rear inner circumferential sides, the outputs of the front outer circumferential sides and the outputs of the rear outer circumferential sides of a forward sub-beam and a rearward sub-beam, wherein the outputs of the respective sides have the same in-phase positional relationship. In addition to the in-phase connections for connecting areas which are in the in-phase positional relationship, in this structure, by providing relative-connections for connecting areas in which each of the four divided areas of the forward sub-beam and the rearward sub-beam are point-symmetrical with respect to the center point of the respective sub-beam light receiving areas, it is possible to switch between the outputs from the in-phase connections and the relative connections by using switch section when the light receiving element is adjusted and when the optical pickup device is practically operated. For example, by performing the switching of the outputs by using the switching capability, the outputs of the in-phase connections can be used when the optical pickup device is practically operated and the outputs of the relative-phase connections can be used when the light receiving element is adjusted.

By adjusting the main-beam to the central position of the main-beam light receiving area and thereafter, switching the sub-beam light receiving areas to the outputs of the relative-connections, the rotation error and the pitch error of the sub-beams can be detected twice as sensitive as those detected by the method in which the one sides of the in-phase connections are open. Thus, an accurate rotation-adjustment and pitch adjustment can be performed, thereby being able to enhance the performance of the optical pickup device. Furthermore, by switching to the in-phase-connection outputs by using the switch section after the rotation-adjustment and the pitch adjustment are performed, it is possible to miniaturize the optical pickup device without increasing the number of output terminals.

Furthermore, by movement-adjusting, performed by a structure capable of movement-adjustment, the grating section in the direction of the optical axis, whereby the grating section is provided in order to form sub-beams which are used for detecting the tracking error, the pitch error of the sub-beams which are incident on the light receiving element can be adjusted, thereby being able to enhance the performance of the optical pickup device.

In another embodiment according to the present invention, two PBSs are used, and a second laser light of two types of laser lights having different wavelengths from each other is incident as an S polarized light on the first PBS, which is arranged farther from the optical recording medium, reflected on the inclined plane (mirror plane) of the first PBS, then transmitted through the inclined plane (mirror plane) of the second PBS, which is arranged closer to the optical recording medium and irradiated onto the optical recording medium.

Additionally, a first laser light of two types of laser lights having different wavelengths from each other is incident as an S polarized light on the second PBS, reflected on the inclined plane (mirror plane) of the second PBS and irradiated onto the optical recording medium.

The polarization component, which is a reflection light reflected from the optical recording medium, is reflected on the inclined plane of the second PBS and then guided to the light receiving element. The lights emitted from the first laser element and the second laser element are both S polarized lights, and both propagate toward the optical recording medium after being reflected on either the first PBS or the second PBS.

Thus, it is possible to cause two types of laser lights directly to be incident on the PBSs and to combine the optical paths of the laser lights, without changing the polarization direction of the light emitted from each of the laser elements by using a ½ wavelength plate, as is performed in the conventional optical pickup device capable of handing two wavelengths. Therefore, it is possible to reduce the number of the components of the device and construct a compact optical pickup device at a low cost. Furthermore, it is possible to irradiate the laser light from the second PBS without using a raise mirror on the optical recording medium, thereby reducing the thickness of the optical pickup device.

Furthermore, as the first PBS, a cube-type polarization beam splitter can be used. However, by using a flat-plate-type polarization beam splitter as the first PBS, it is possible to further miniaturize and reduce the cost of the optical pickup device.

Furthermore, by providing a light receiving element for power control on the second PBS and detecting a portion of the laser light by using the light receiving element for power control, it is possible to adjust the output of the semiconductor laser element (light source) and to improve the stability of the output of the light. For example, a portion of the first laser light which is reflected on the inclined plane of the second PBS can be transmitted through the inclined plane of the second PBS and then guided to the light receiving element for power control. Furthermore, a portion of the second laser light which is incident on the second PBS after being reflected on the inclined plane of the firs PBS can be reflected on the inclined plane of the second PBS and then guided to the light receiving element for power control.

Furthermore, by attaching a ¼ wavelength plate to the light emission side of the second PBS, it is possible to reduce the area of the ¼ wavelength plate and to miniaturize the optical pickup device. Furthermore, since the rotation error which occurs at the time of attachment can be reduced and the freedom of selecting a focusing distance of the collimate lens can expand, it is possible to enhance the reliability of the optical pickup device.

Furthermore by integrating the second PBS, the ¼ wavelength plate and the light receiving element for power control together and placing a portion thereof in a drum of an actuator for driving an objective lens, it is possible to minimize the optical path length of the optical pickup device, thereby being able to construct a highly densified compact optical pickup device.

Furthermore, by taking out a semi-circular part or a circular part of the drum of the actuator and causing the actuator to follow the focusing direction, it is possible not to block the optical path of the first laser light, thereby being able to arrange the light flux at an optimal position.

Furthermore, since astigmatism, which is used in a commonly-used focus error detection method, is generated, in a cylindrical lens arranged on the light incidence side of the light receiving element, the rotation error of a light receiving spot with respect to dividing lines of the light receiving element may occur due to (i) the rotation error of the light receiving spot resulting from the design and manufacturing error of the cylindrical lens and (ii) the rotation error which is caused at the time of mounting the light receiving element. As a result, the diffraction pattern of a push-pull signal which crosses the tracks of the optical recording medium includes an angle error with respect to the dividing lines of the light receiving elements. Therefore, an accurate push-pull diffraction signal cannot be obtained. By rotation-adjusting, performed by a structure capable of rotation-adjustment, the cylindrical lens with the optical axis as its center, it is possible that the light of the diffraction pattern of a push-pull signal, which crosses the tracks of the optical recording medium, is accurately received with respect to the dividing lines of the light receiving element. Thus, it is possible to generate a stable tracking error signal and focus error signal.

Furthermore, in the four-divided sub-beam light receiving areas, which are provided in order to detect the tracking error, it is commonly practiced to reduce the number of the output terminals by respectively connecting the outputs of the front inner circumferential sides, the outputs of the rear inner circumferential sides, the outputs of the front outer circumferential sides and the outputs of the rear outer circumferential sides of a forward sub-beam and a rearward sub-beam, wherein the outputs of the respective sides have the same in-phase positional relationship. In addition to the in-phase connections for connecting areas which are in the in-phase positional relationship, in this structure, by providing relative-connections for connecting areas in which each of the four divided areas of the forward sub-beam and the rearward sub-beam are symmetrical with respect to each other, it is possible to switch between the outputs of the in-phase connections and the relative connections by using switch section when the light receiving element is adjusted and when the optical pickup device is practically operated. For example, the outputs of the in-phase connections can be used when the optical pickup device is practically operated and the outputs of the relative-phase connections can be used when the light receiving element is adjusted.

By adjusting the main-beam to the central position of the main-beam light receiving area and thereafter, switching the sub-beam light receiving areas to the outputs of the relative-connections, the rotation error and the pitch error of the sub-beams can be detected twice as sensitive as those detected by the method in which the one sides of the in-phase connections are open. Thus, an accurate rotation-adjustment and pitch adjustment can be performed, thereby being able to enhance the performance of the optical pickup device. Furthermore, by switching to the in-phase connection outputs after the rotation-adjustment and the pitch adjustment are performed, the number of output terminals can be reduced, thereby being able to miniaturize the optical pickup device.

Furthermore, by movement-adjusting, performed by a structure capable of movement-adjustment, the grating section in the direction of the optical axis, whereby the grating section is provided in order to form the sub-beams which are used for detecting the tracking error, the pitch error of the sub-beams which are incident on the light receiving element can be adjusted, thereby being able to enhance the performance of the optical pickup device.

As described above, according to the present invention, in the optical pickup device capable of handling two wavelengths, two types of lights (e.g., laser lights) having different wavelengths from each other are incident on the first PBS, which is arranged farther from the optical recording medium, from different directions from each other, both of them, for example, as P polarized lights. In accordance with each of the wavelengths emitted from light sources (e.g., semiconductor laser elements), one of them is transmitted through the inclined plane (mirror plane) of the first PBS and the other is reflected on the inclined plane of the first PBS and then combined into the same optical path. The P polarized light emitted from the first PBS is transmitted through the inclined plane of the second PBS, which is arranged closer to the optical recording medium, and irradiated onto the optical recording medium. The polarization component which is a return light from the optical recording medium is reflected on the mirror plane of the second PBS and guided to the light receiving element. As a result, a ½ wavelength plate which is conventionally required in order to cause the laser lights to be incident on the two PBSs is not needed, thereby being able to miniaturize and reduce the cost of the optical pickup device. Furthermore, by reflecting the polarization component, which is reflected by the optical recording medium, on the second PBS arranged before the semiconductor laser elements as light sources and guiding the polarization component to the light receiving element, the amount of return light to the semiconductor laser elements is reduced and the noise occurrence is suppressed, thereby being able to enhance the reliability of the optical pickup device. Furthermore, by attaching the ¼ wavelength plate to the second PBS, it is possible to miniaturize the optical pickup device.

Furthermore, by increasing the freedom of arranging the light receiving element for power control, the freedom of designing the PBSs is increased, thereby being able to reduce the cost of the PBSs. Furthermore, by rotation-adjusting the cylindrical lens with the optical axis as its center, a stable tracking error signal and focus error signal can be produced, thereby being able to enhance the reliability of the optical pickup device. Furthermore, by switching between the outputs of the in-phase connections and the outputs of the relative-phase connections in the four-divided sub-beam light receiving areas for detecting the tracking error by using the switching section, it is possible to enhance the adjustment accuracy for the sub-beam position without increasing the number of output terminals. Furthermore, by movement-adjusting the grating section, which is used for generating sub-beams for detecting the tracking error, in the direction of the optical axis, it is possible to adjust the pitch error of the sub-beams.

According to another embodiment of the present invention, in the optical pickup device capable of handing two wavelengths, a second laser light of two types of laser lights is incident as an S polarized light on the first PBS, which is arranged farther from the optical recording medium, reflected on the inclined plane of the first PBS, then transmitted through the inclined plane of the second PBS, which is arranged closer to the optical recording medium and irradiated onto the optical recording medium. A first laser light of two types of the laser lights is incident as an S polarized light on the second PBS, reflected on the inclined plane of the second PBS and irradiated onto the optical recording medium. The polarization component, which is a reflection light reflected from the optical recording medium is reflected on the inclined plane of the second PBS and then guided to the light receiving element. As a result, a ½ wavelength plate which is conventionally required in order to cause the laser lights to be incident on the two PBSs is not needed, thereby being able to miniaturize and reduce the cost of the optical pickup device. Furthermore, since a raise mirror is not used, it is possible to miniaturize the optical pickup device. Furthermore, by constructing the first PBS with a flat-plate, it is possible to miniaturize and reduce the cost of the optical pickup device. Furthermore, by attaching the ¼ wavelength plate to the second PBS, it is possible to miniaturize the optical pickup device. Furthermore, by integrating the second PBS, the light receiving element for power control and the ¼ wavelength plate together and placing a portion thereof in the drum of the actuator for driving the objective lens, it is possible to miniaturize the optical pickup device.

Furthermore, by increasing the freedom of arranging the light receiving element for power control, the freedom of designing the PBSs is increased, thereby being able to reduce the cost of the PBSs. Furthermore, by rotation-adjusting the cylindrical lens with the optical axis as its center, a stable tracking error signal and focus error signal can be produced, thereby being able to enhance the reliability of the optical pickup device. Furthermore, by switching between the outputs of the in-phase connections and the outputs of the relative-phase connections in the four-divided sub-beam light receiving areas for detecting the tracking error by using the switch section, it is possible to enhance the adjustment accuracy for the sub-beam position without increasing the number of output terminals. Furthermore, by movement-adjusting the grating section, which is used for generating sub-beams for detecting the tracking error, in the direction of the optical axis, it is possible to adjust the pitch error of the sub-beams.

These and other advantages of the present invention will become apparent to those skilled in the art upon reading and understanding the following detailed description with reference to the accompanying figures.

### BRIEF DESCRIPTION OF THE DRAWINGS

FIG. 1 is a perspective view showing a structural example of important parts of an optical pickup device capable of handling two wavelengths according to Embodiment 1 of the present invention.

FIG. 2 is a circuit diagram showing a state of terminal connection of the light receiving element in FIG. 1.

FIG. 3 is a schematic view for explaining the polarization direction of the laser light in an optical system in the optical pickup device in FIG. 1; (a) is a view showing a light emission path from the semiconductor elements to the optical disk and (b) is a view showing a light receiving path from the optical disk to the light receiving element.

FIG. 4(a) is a view showing a state of a light receiving spot on the light receiving element on which a light including a diffraction pattern is reflected at a land portion and a focus is adjusted; (b) is a view showing a state of the light receiving spot on the light receiving element when the switching is performed from a land portion to a groove portion, in the optical pickup device shown in FIG. 1.

FIG. 5 is a perspective view showing another structural example of important parts of an optical pickup device capable of handling two wavelengths according to Embodiment 1 of the present invention.

FIG. 6 is a perspective view showing a structural example of important parts of an optical pickup device capable of handling two wavelengths according to Embodiment 2 of the present invention.

FIG. 7 is a view showing in further detail the structural example of important parts of the optical pickup device capable of handling two wavelengths shown in FIG. 6; (a) is a perspective view thereof and 7(b) is a longitudinal cross-sectional view thereof.

FIG. 8 is a schematic view for explaining the polarization direction of the laser light in an optical system in the optical pickup device capable of handling two wavelengths shown in FIG. 6; (a) is a view showing a light emission path from the semiconductor elements to the optical disk and (b) is a view showing a light receiving path from the optical disk to the light receiving element.

FIG. 9 is a perspective view for comparing the thickness of a conventional optical pickup device and the optical pickup device according to Embodiment 2 shown in FIG. 6

FIG. 10 is a perspective view showing a structural example of important parts of the conventional optical pickup device capable of handling two wavelengths.

FIG. 11 is a schematic view for explaining the polarization direction of the laser light in an optical system in the optical pickup device shown in FIG. 10; (a) is a view showing a light emission path from the semiconductor laser elements to the optical disk and (b) is a view showing a light receiving path from the optical disk to the light receiving element.

FIG. 12 is a circuit diagram showing a state of terminal connection of the light receiving element in the conventional optical pickup device disclosed in References 4 and 5.

FIG. 13 is a schematic view for explaining a DVD-RAM optical disk; (a) is a perspective view showing important parts of the optical pickup device for the optical disk for explaining a land portion of the optical disk; (b) is a view showing an image of a land portion; and a state of a light receiving spot on a light receiving element when a light including a diffraction pattern is reflected at the land portion of the optical disk; (c) is a perspective view showing important parts of the optical pickup device for the optical disk for explaining a groove portion of the optical disk; (d) is a view showing an image of a groove portion; and a state of a light receiving spot on a light receiving element when a light including a diffraction pattern is reflected at the groove portion of the optical disk.

FIG. 14 is a case in which there is no relative rotation error between a light receiving spot and four-dividing lines of the light receiving element, and the diffraction pattern and the four-dividing lines are positioned so as to be symmetrical to each other with respect to a horizontal direction and a vertical direction; (a) is a view showing a state of a light receiving spot on a light receiving element when a light including a diffraction pattern is reflected at a land portion; and (b) is a view showing a state of the light receiving spot on the light receiving element when the switching is performed from a land portion to a groove portion.

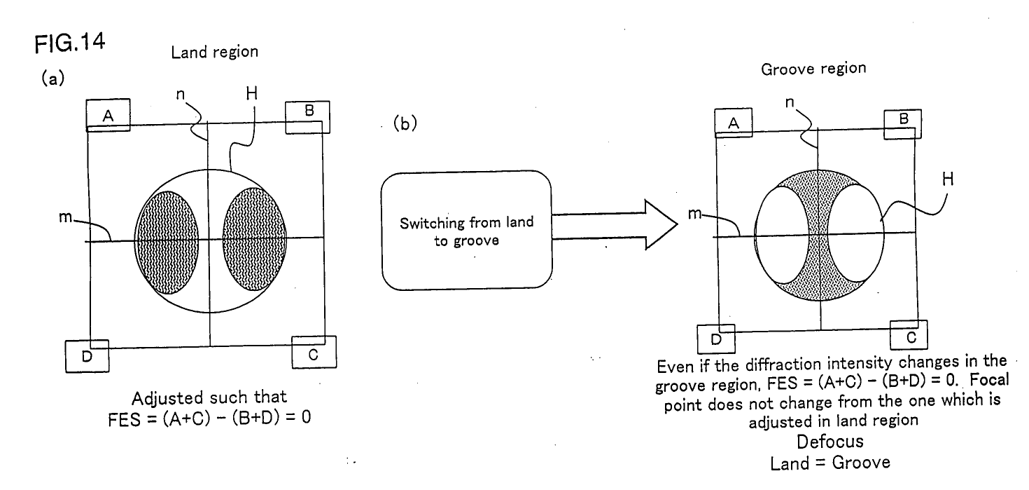

FIG. 15 is a case in which the light receiving spot and the four-dividing lines of the light receiving element are not line-symmetrical to each other due to the occurrence of the rotation error; (a) is a view showing a state of a light receiving spot on a light receiving element when a light including a diffraction pattern is reflected at a land portion; (b) is a view showing a state of the light receiving spot on the light receiving element on which a beam is deformed and a focus is adjusted; and (c) is a view showing a state of the light receiving spot on the light receiving element when the switching is performed from a land portion to a groove portion.

### DESCRIPTION OF THE PREFERRED EMBODIMENTS

Hereinafter, cases, in which Embodiments 1 and 2 of an optical pickup device according to the present invention are adapted to an optical pickup device capable of handling two wavelengths, will be described in detail with reference to the accompanying figures.

The optical pickup device capable of handling two wavelengths according to the present invention has two light sources which emit laser lights having different wavelengths from each other. The optical pickup device according to the present invention is characterized in that the two light sources both emit either P polarized lights or S polarized lights, and each of the light sources is arranged at a predetermined position in accordance with the polarization direction of the respectively emitted laser lights.

### EMBODIMENT 1

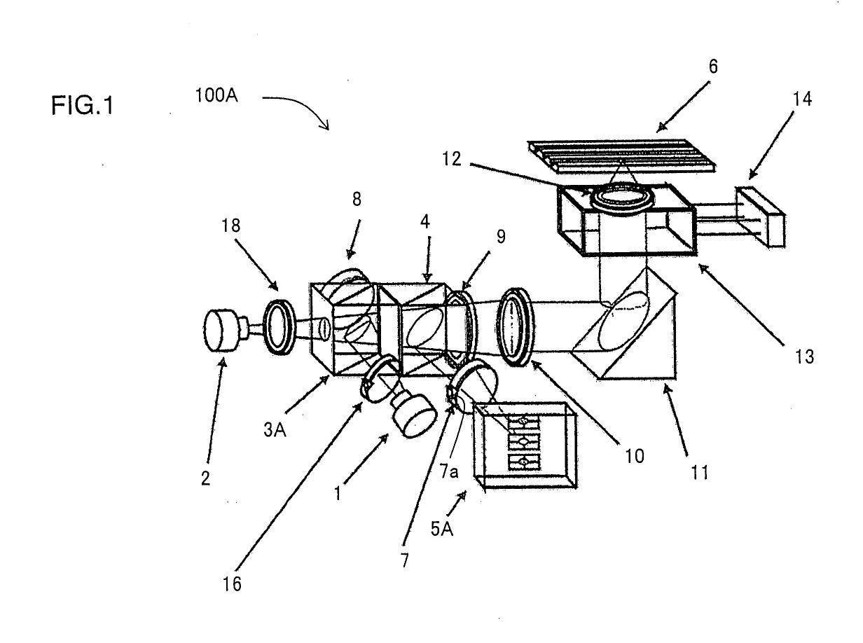

FIG. 1 is a perspective view showing a structural example of important parts of an optical pickup device capable of handling two wavelengths according to Embodiment 1 of the present invention.

In FIG. 1, the optical pickup device 100A capable of handling two wavelengths includes a semiconductor laser element 1 for DVD which has a relatively short-wavelength, a semiconductor laser element 2 for CD which has a relatively long-wavelength, a cube-type first PBS 3A arranged farther from an optical disk 6, a cube-type second PBS 4 arranged closer from the optical disk 6 and a light receiving element 5A for receiving a reflection light reflected from the optical disk 6.

Laser lights from the semiconductor laser elements 1 and 2 are incident on the first PBS 3A, both of them as P polarized lights, from different directions from each other. The laser light from the semiconductor laser element 1 having a short-wavelength is reflected on the inclined plane (mirror plane) of the first PBS 3A toward the optical path on the optical disk 6 side. The laser light from the semiconductor laser element 2 having a long-wavelength is transmitted through the inclined plane of the first PBS 3A toward the optical path on the optical disk 6 side. An S polarized light which is reflected on the inclined plane of the second PBS 4 is guided to the light receiving element 5A.

Along the optical path from the second PBS 4 to an optical disk 6, a ¼ wavelength plate 9 for changing the phase of the laser light by π/4, a collimate lens 10 for collimating the laser light from the ¼ wavelength plate 9 into a collimate light, a raise mirror 11 for bending the optical path of the light by 90 degrees and an objective lens 12 for focusing the light onto the plane of the optical disk 6 are provided. An actuator drum 13 and an actuator supporting body 14 for supporting the actuator drum 13 are provided on the objective lens 12 in order to adjust the position of the objective lens 12.

A cylindrical lens 7 is provided between the second PBS 4 and the light receiving element 5A in order to generate astigmatism which is used for detecting a focus error. In the cylindrical lens 7, an adjustment section (cylindrical lens adjusting section) (not shown) for performing a rotation-adjustment as the optical axis as its center is provided. Furthermore, in order to facilitate the rotation-adjustment, a notched portion 7a is provided in the cylindrical lens 7.

Furthermore, on the side opposite to the semiconductor laser element 1 with respect to the first PBS 3A, a light receiving element 8 for power control is provided in order to detect a laser power and adjust an output of the laser light.

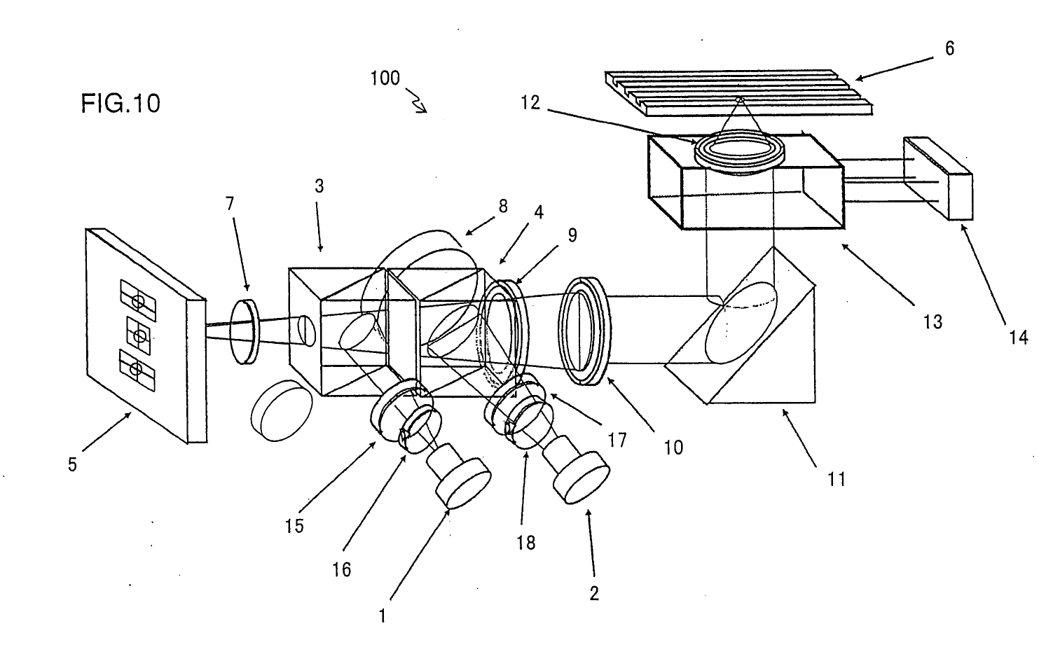

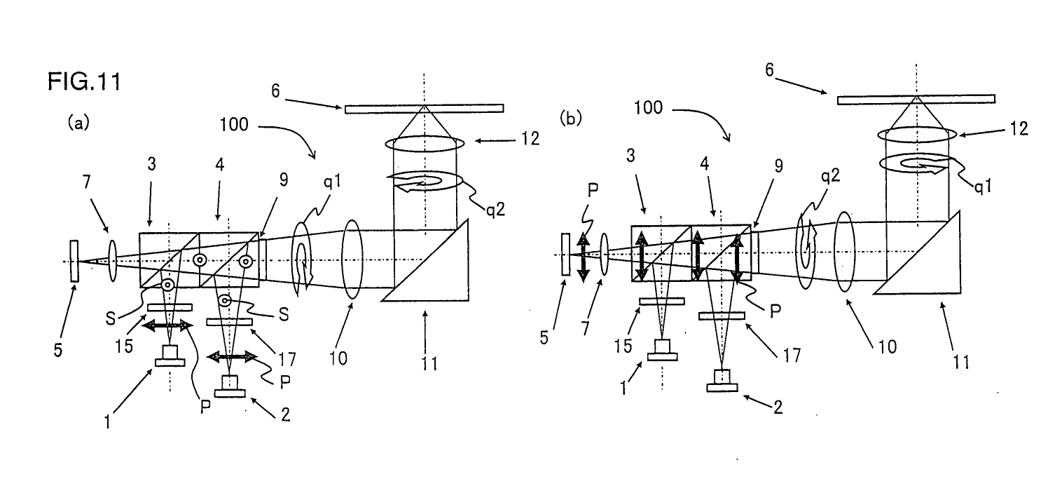

Furthermore, between the semiconductor laser element 1 and the first PBS 3A, a three-beam grating 16 is provided as a grating section in order to form a main-beam as well as two sub-beams which are used for detecting a tracking error. Between the semiconductor laser element 2 and the first PBS 3A, a three-beam grating 18 is provided as a grating section in order to form a main-beam as well as two sub-beams which are used for detecting a tracking error. In each of the three-beam gratings 16 and 18, an adjustment section (not shown) is provided in order to perform a movement-adjustment in the direction of the optical axis. Furthermore, on the light emission side of each of the three-beam gratings 16 and 18, no ½ wavelength plate which is used in the conventional technique shown in FIGS. 10 and 11 is provided, and the laser lights from the semiconductor laser elements 1 and 2 are respectively incident on the first PBS 3A without propagating through the conventional ½ wavelength plate.

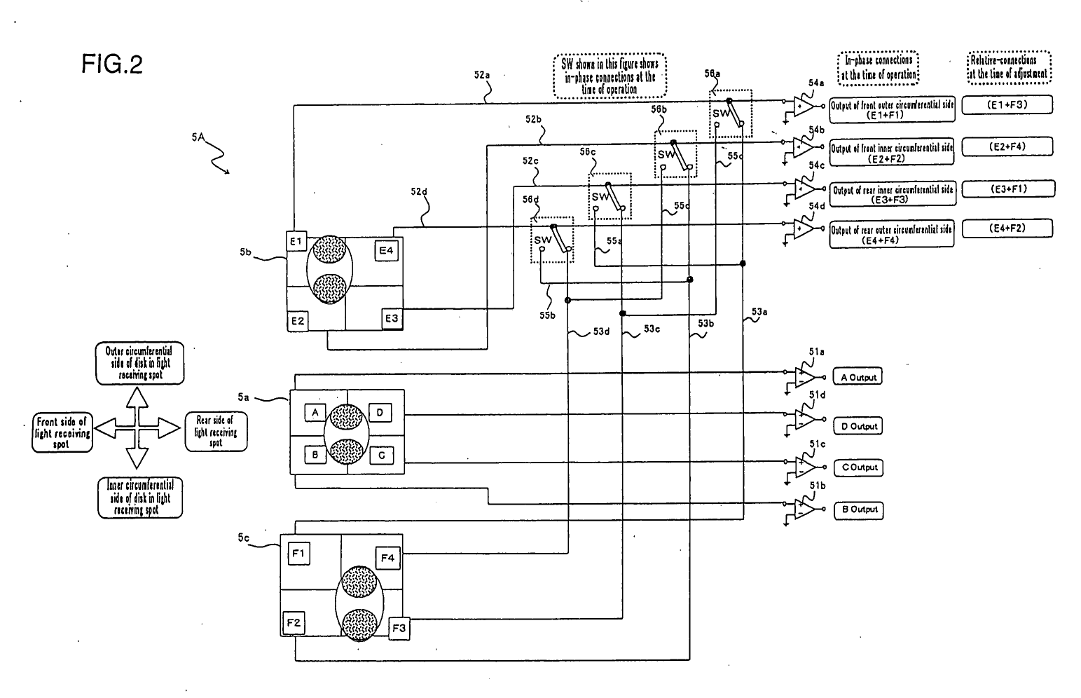

FIG. 2 is a circuit diagram showing a state of terminal connection of the light receiving element in FIG. 1.

In FIG. 2, the receiving element 5A includes a main-beam light receiving area 5a for detecting a focus error and two sub-beam light receiving areas 5b and 5c for detecting a tracking error.

The astigmatism is given to each light flux by the cylindrical lens 7 in order to detect the focus error. The main-beam light receiving area 5a is divided into four areas (A to D). When each of the areas A, B, C, D which are obtained by dividing the light receiving area 5a into four is described, the top-to-bottom direction (longitudinal direction) in FIG. 2 corresponds to the outer circumferential side and the inner circumferential side of the optical disk. The upper side corresponds to the outer circumferential side of the optical disk and the lower side corresponds to the inner circumferential side of the optical disk. Furthermore, the left-to-right direction (lateral direction) in FIG. 2 corresponds to the front side and the rear side of the optical disk. The left side corresponds to the front side of a light receiving spot H and the right side corresponds to the rear side of the light receiving spot H. For example, in the main-beam light receiving area 5a, the four divided areas A, B, C, D respectively correspond to signal outputs of the front outer circumferential side, the front inner circumferential side, the rear inner circumferential side, and the rear outer circumferential side of the optical disk.

When the signal output from each of the four-divided areas A to D satisfies
FES=(A+C)−(B+D)=0,
the main-beam light receiving area 5a is determined to be in a focus state. Otherwise, the main-beam light receiving area 5a is determined to be out of the focus state, thereby the focus error signal being detected. For this reason, signal output terminals 51a to 51d are connected to the corresponding four-divided areas A to D of the main-beam light receiving area 5a, respectively.

Additionally, each of light fluxes is divided into one main-beam and two sub-beams by the three-beam gratings 16 and 18, respectively, in order to detect the tracking error. Each of the light receiving areas 5b and 5c of the two sub-beams is divided into four-divided areas E1 to E4 and F1 to F4, respectively. Herein, the sub-beam four-divided areas E1 and F1 represent the signal outputs of the front outer circumferential side of the optical disk, the sub-beam four-divided areas E2 and F2 represent the signal outputs of the front inner circumferential side of the optical disk, the sub-beam four-divided areas E3 and F3 represent the signal outputs of the rear inner circumferential side of the optical disk, and the sub-beam four-divided areas E4 and F4 represent the signal outputs of the rear outer circumferential side of the optical disk. In detecting the tracking error, when the signal output from each of the four-divided areas satisfies the following expressions;
(E1+F1)+(E2+F2)=(E3+F3)+(E4+F4),
and
(E1+F1)+(E4+F4)=(E2+F2)+(E3+F3),
it is detected that there is no relative rotation error or no pitch error between the two sub-beams and the light receiving element 5.

As described above, as shown in FIG. 2, the connections 52a to 52d and the in-phase connections 53a to 53d are provided in the light receiving element 5A so as to connect therein the signal outputs of the four-divided areas E1 and F1, the signal outputs of the four-divided areas E2 and F2, the signal outputs of the four-divided areas E3 and F3 and the signal outputs of the four-divided areas E4 and F4, respectively, wherein both four-divided areas of each pairing have the same in-phase positional relationship. Main output terminals 54a to 54d are provided so as to be connected to the front outer circumferential side, the front inner circumferential side, the rear inner circumferential side, and the rear outer circumferential side of the optical disk, respectively.

Furthermore, in Embodiment 1, relative connections 55a to 55d are provided in the light receiving element 5 so as to connect therein the signal outputs of the four-divided areas E1 and F3, the signal outputs of the four-divided areas E2 and F4, the signal outputs of the four-divided areas E3 and F1 and the signal outputs of the four-divided areas E4 and F2, both of which are point-symmetrical with respect to the centers of the respective sub-beam light receiving areas 5b and 5c. Furthermore, switches 56a to 56d are provided as a switching section. With the switches 56a to 56d, the in-phase connection 53a and the relative connection 55c are switched for the connection 52a, the in-phase connection 53b and the relative connection 55d are switched for the connection 52b, the in-phase connection 53c and the relative connection 55a are switched for the connection 52c and the in-phase connection 53d and the relative connection 55b are switched for the connection 52d. The connections 52a to 52d are connected to output terminals 54a to 54d, respectively.

As described above, for the connections 52a to 52d, (i) the conventionally-used connections (i.e., in-phase connections 53a to 53d) for connecting the corresponding four-divided areas between each of the sub-beam light receiving areas 5b and 5c, which have the in-phase positional relationship, and (ii) the connections (i.e., relative connections 55a to 55d) for connecting the four-divided areas in the sub-beam light receiving area 5b and the corresponding four-divided areas in the sub-beam light receiving area 5c, which are point-symmetrical with respect to the centers of the respective sub-beam light receiving areas 5b and 5c are provided. Furthermore, owing to the switches 56a to 56d which switch between two types of the connections (in-phase connection and relative-phase connection), the connections can be selected and used at time of the practical operation and at the time of adjusting the light receiving element 5, respectively, thereby being able to improve the adjustment accuracy for the sub-beam position without increasing the number of the output terminals 54a to 54d.

Owing to the structure described above, hereinafter, the operation of the optical pickup device 100A capable of handling two wavelengths according to Embodiment 1 will be described.

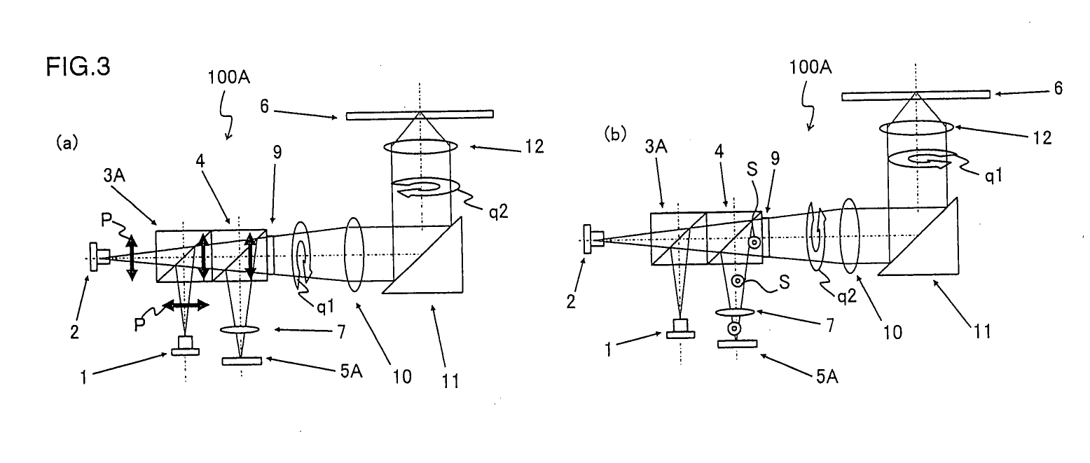

FIG. 3 is a schematic view for explaining the polarization direction of the laser light in an optical system in the optical pickup device 100A capable of handling two wavelengths shown in FIG. 1. FIG. 3(a) is a view showing a light emission path from the semiconductor elements 1 and 2 to the optical disk 6. FIG. 3(b) is a view showing a light receiving path from the optical disk 6 to the light receiving element 5. In FIG. 3(a) and FIG. 3(b), arrows represent the P polarized light parallel to the surface of FIG. 3, and double circles represent the S polarized light vertical to the surface of FIG. 3.

The light emission path from the semiconductor laser elements 1 and 2 to the optical disk 6 will be described with reference to FIG. 3(a).

As shown in FIG. 3(a), the P polarized laser light emitted from the semiconductor laser element 1 for a short-wavelength light (for DVD) is divided into three beams by the three-beam grating 16 and then reflected by the inclined plane of the first PBS 3A. Concurrently, a portion of the light is transmitted through the inclined plane of the first PBS 3A and then incident on the light receiving element 8 for power control. In contrast, the P polarized laser light emitted from the semiconductor laser element 2 for a long-wavelength light (for CD) is divided into three beams by the three-beam grating 18 and then transmitted through the inclined plane of the first PBS 3A.

The laser lights which are emitted from the semiconductor laser elements 1 and 2 are both incident on the second PBS 4 as originally P polarized lights, transmitted through the inclined plane of the second PBS 4 and then converted into a circularly polarized light q1 by the ¼ wavelength plate 9. The circularly polarized light q1 is right-handed clockwise direction with respect to its propagating direction. The second PBS 4 is a polarization beam splitter for reflecting the light thereon or transmitting the light therethrough depending on the polarization direction of the incident light.

The circularly polarized light q1 in the clockwise direction from the ¼ wavelength plate 9 is converted into a collimate light by the collimate lens 10, reflected by the raise mirror 11, and the propagating direction of the light is bent by 90 degrees. The circularly polarized light q1 is converted into a circularly polarized light q2, which is left-handed anti-clockwise direction with respect to its propagating direction, and focused onto the information recording plane of the optical disk 6 by the objective lens 12.

As shown in FIG. 3(b), the direction of the circularly polarized light of the reflection light reflected from the optical disk 6 is opposite to that shown in FIG. 3(a), and the reflection light is converted into the S polarized light by the ¼ wavelength plate 9 after propagating through the objective lens 12, the raise mirror 11 and the collimate lens 10. The S polarized light is reflected on the inclined plane of the second PBS 4 and the propagating direction of the light is bent by 90 degrees. Then, the S polarized light is incident on the light receiving element 5A through the cylindrical lens 7.

As described above, by providing the light receiving element 5A on the reflection side of the second PBS 4 so as to guide the S polarized light, which is reflected from the optical disk 6, to the light receiving element 5A by the second PBS 4 before the S polarized light reaches the semiconductor laser elements 1 and 2, there is no presence of a light returning to the semiconductor laser elements 1 and 2. As a result, occurrence of noise is suppressed.

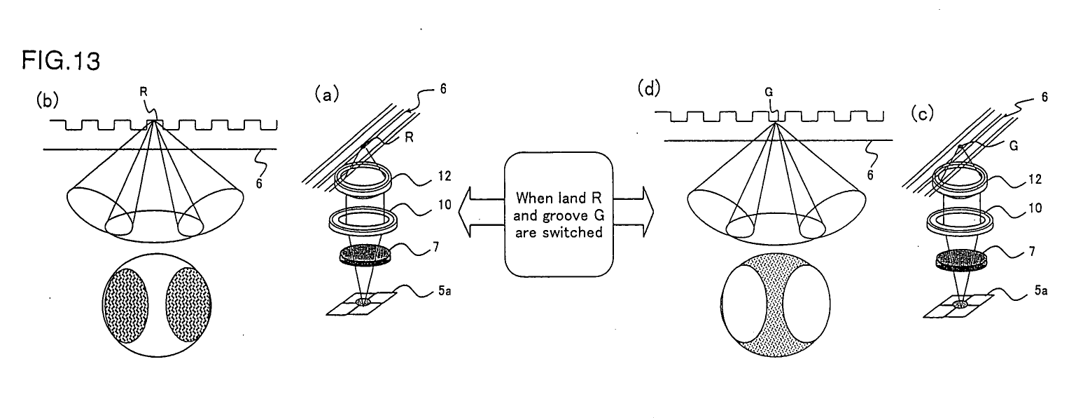

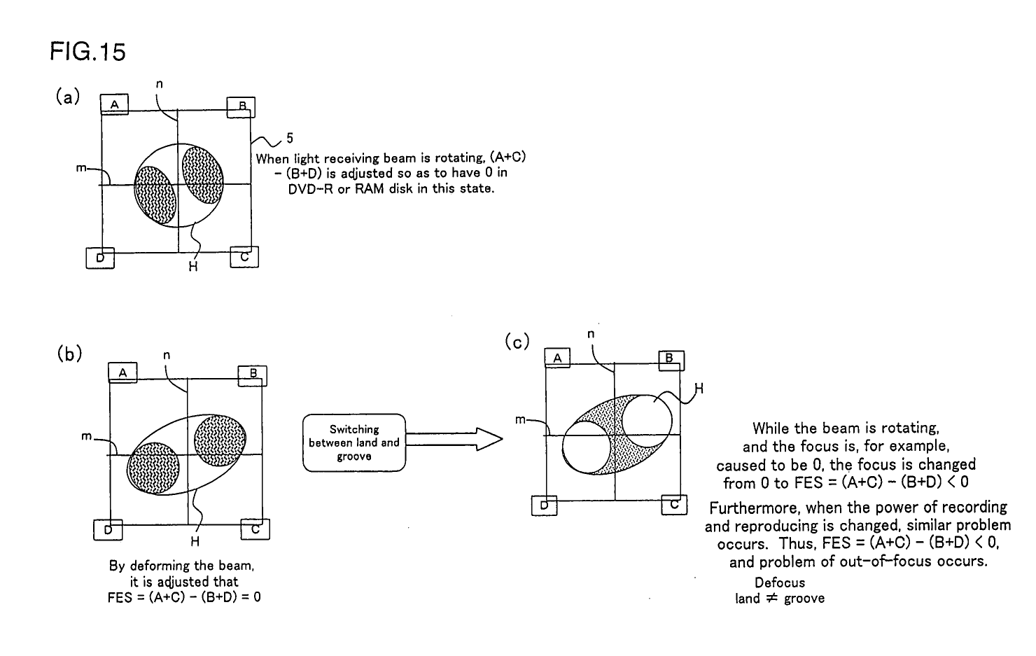

In the optical pickup device 100A capable of handling two wavelengths according to Embodiment 1, when information is recorded/reproduced on/from a special recording medium (e.g., DVD-R and DVD-RAM) shown in FIG. 13 in which the information can be recorded on a land portion (land R) and a groove portion (groove G) of the optical disk 6, it is possible to perform the rotation-adjustment on the cylindrical lens 7 by the adjustment section (not shown) with the optical axis as its center so that the focus error does not occur between the land portion R and the groove G shown in FIG. 15. Furthermore, in order to facilitate the rotation-adjustment, the notched portion 7a is provided in the cylindrical lens 7 as shown in FIG. 1.

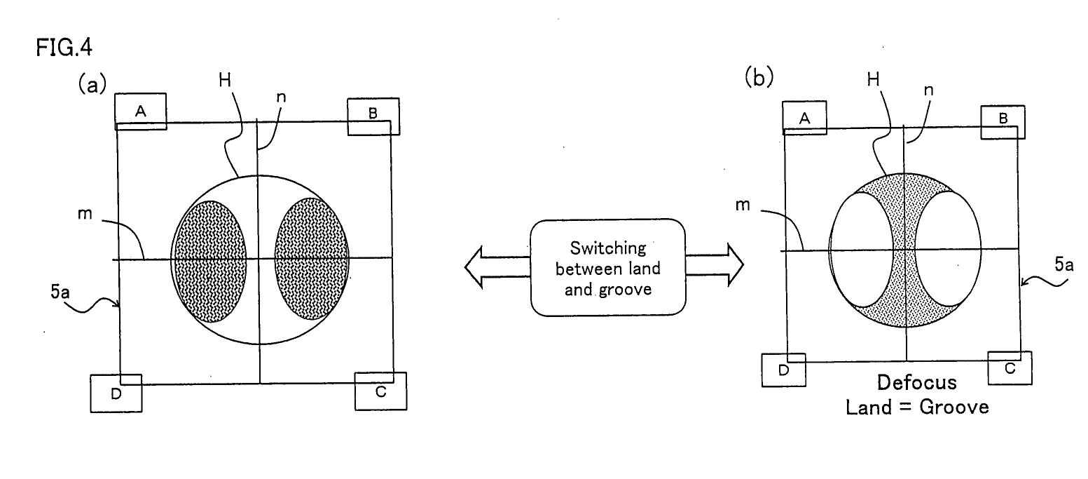

For example, as shown in FIGS. 4(a) and (b), the cylindrical lens 7 is rotation-adjusted with the optical axis as its center until
FES=(A+C)−(B+D)=0
is established such that the focus value of the land portion and the focus value of the groove portion on the optical recording medium at the time of adjusting the focus are the same. Herein, as shown in FIGS. 4(a) and (b), in the land portion and the groove portion, the light-dark in the diffraction pattern of the light which is irradiated on the main-beam light receiving area 5a for detecting the focus error is reversed. Thus, it is necessary to eliminate the rotation error of the light receiving spot H relative to the light receiving element 5A in order that focus states in different diffraction patterns coincide with each other.

By rotation-adjusting the cylindrical lens 7 such that the focus value of the land portion shown in FIG. 4(a) and the focus value of the groove portion shown in FIG. 4(b) are the same, the light receiving spot H on the light receiving element 5 (light receiving area 5a) is rotated. As a result, the light receiving spot H on the light receiving element 5A is line-symmetrical with respect to dividing lines m and n. Thus, the out-of-focus difference between the land portion and the groove portion does not occur. Furthermore, at the time of recording information or at the time of reproducing information, the focus offset (the focus position is changed when being switched to semiconductor laser element 1 or 2), which occurs when the laser power is switched, is minimized, thereby improving the stability of the optical pickup device.

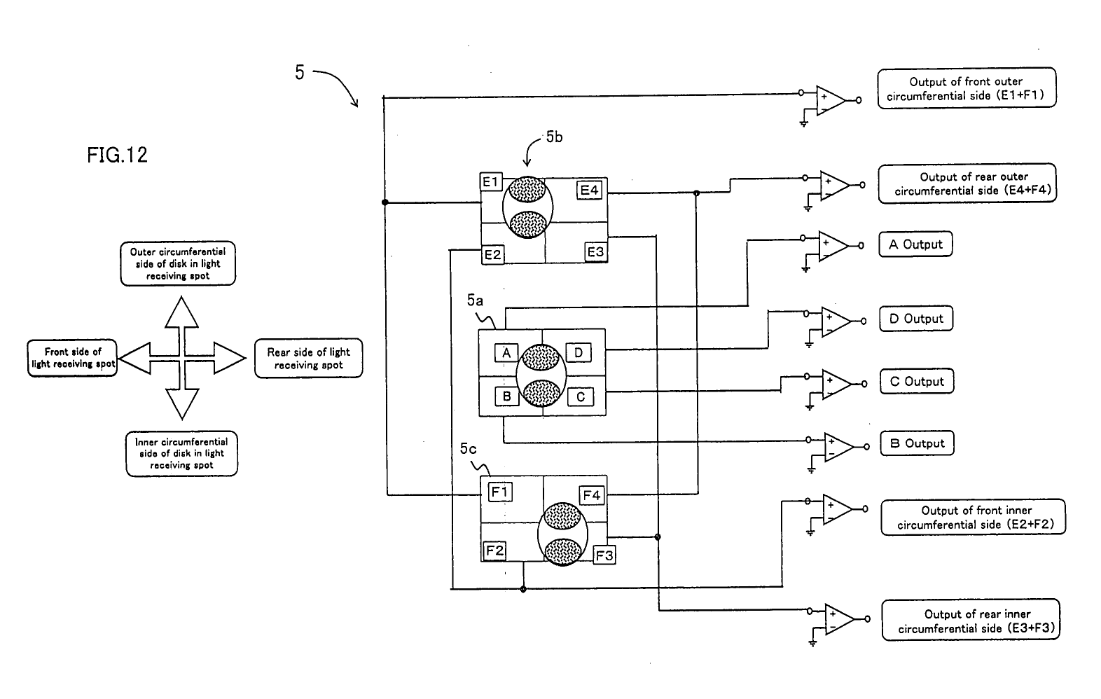

In the optical pickup device 100A capable of handling two wavelengths according to Embodiment 1, as in the case of the conventional technology shown in FIG. 12, when the number of the output terminals is reduced by connecting the four-divided areas E1 and F1, the four-divided areas E2 and F2, the four-divided areas E3 and F3 and the four-divided areas E4 and F4 for output, respectively, wherein both four-divided areas of each pairing in the two sub-beam light receiving areas 5b and 5c have the same in-phase positional relationship, in order to solve the problem that the positional relationship of the light receiving spot H relative to the sub-beam which is divided into four areas cannot be detected from the output of the sub-beam, the switches 56a to 56d are respectively provided for switching between the output from the in-phase connection 53a and the output from the relative-phase 55c for the output of the connection 52a, between the output from the in-phase connection 53b and the output from the relative-phase 55d for the output of the connection 52b, between the output from the in-phase connection 53c and the output from the relative-phase 55a for the output of the connection 52c, and between the output from the in-phase connection 53d and the output from the relative-phase 55b for the output of the connection 52d such that the four-divided areas E1 and F3, the four-divided areas E2 and F4, the four-divided areas E3 and F1 and the four-divided areas E4 and F2 are connected, respectively, wherein both four-divided areas of each pairing are point-symmetrical with respect to the center of the respective light receiving areas 5b and 5c as shown in FIG. 2.

For example, as shown in FIG. 2, when the light receiving element 5A is adjusted and when the optical pickup device 100A is practically operated, it is possible to switch the intra-connections by using the switches 56a to 56d. When the optical pickup device 100A is practically operated, by selecting the in-phase connection 53a to 53d and respectively connecting the connection 52a and the in-phase connection 53a, the connection 52b and the in-phase connection 53b, the connection 52c and the in-phase connection 53c and the connection 52d and the in-phase connection. 53d to the corresponding output terminals 54a to 54d, the number of output terminals is reduced as done conventionally. However, in addition, when the light receiving element 5A is adjusted, by selecting the relative phase connections 55a to 55d which have a reverse phase (point-symmetrical with respect to the centers of respective four divided areas) and respectively connecting them to the corresponding output terminals 54a to 54d, it is possible to clearly output the positional error between the light receiving spot H and each of the four-divided areas.

In the structure of the conventional technique shown in FIG. 12, in which the number of the output terminals is reduced by in-phase connecting the four-divided areas E1 and F1, the four-divided areas E2 and F2, the four-divided areas E3 and F3 and the four-divided areas E4 and F4 so as to output signals, respectively, wherein both four-divided areas of each pairing have the same in-phase positional relationship, a method, which detects the positional error by using the output from one side of the sub-beams once the intra-connections are open at the time of adjustment, is considered. However, rather than using this method, by making relative connections of the four-divided areas E1 and F3, the four-divided areas E2 and F4, the four-divided areas E3 and F1 and the four-divided areas E4 and F2 so as to output the signals, it is possible to further clarify the inherently weak sub-beam output since twice as many output signals are output. Owing to this, compared to the method, which detects the positional error by using the output from one side of the sub-beams once the intra-connections are open, it is possible to more clearly identify the relative rotation error and the pitch error of the sub-beam light receiving areas 5b and 5c and the light receiving element 5A.

Furthermore, in the optical pickup device 100A capable of handling two wavelengths according to Embodiment 1, it is possible to adjust the three-beam gratings 16 and 18 by the adjustment section (not shown) such that the pitch error of the sub-beam which is incident on the light receiving element 5A is adjusted.

It is possible to adjust the pitch of the sub-beam on the light receiving element 5A by moving the position in the optical axis direction of the three-beam gratings 16 and 18.

For example, when the focusing distance of the collimate lens 10 is denoted as f1, the focusing distance of the objective lens 12 is denoted as f2, the distance between the semiconductor laser element 1 (or 2) and the three-beam grating 16 (or 18) is denoted as L1, the distance between the three-beam grating 16 (or 18) and the collimate lens 10 is denoted as L2, the grating pitch is denoted as Gp, and the usable wavelength is denoted as λ, then the pitch P on the optical disk is given by
P=(f2/f1)×(f1−L2)×(λ/Gp)/(SQR(1−(λ/Gp)²))
Furthermore, when the focusing distance to a light receiving portion is denoted as f3, it is possible to adjust the pitch of the three beams on the light receiving element 5A by adjusting the position of the optical axis direction of the three-beam gratings 16 and 18 since the ratio between the focusing distance f1 and the focusing distance f3 is the ratio between the pitch of the sub-beam on the optical disk 6 and the pitch of the sub-beam on the light receiving element 5A.

Thus, it is possible to adjust the output balance of the relative connections 55a to 55d shown in FIG. 2 so as to be uniform by adjusting the three-beam gratings 16 and 18 shown in FIG. 1 in the optical axis direction. As a result, the offset of the tracking error signal is different between the tracks of recorded section and the tracks of unrecorded section in DPP method due to the pitch error, thereby being able to solve the problem that the servo control of the optical pickup device becomes unstable.

As described above, according to the optical pickup device 100A capable of handling two wavelengths of Embodiment 1, the P polarized light from the semiconductor laser element 1 for DVD which has a relatively short-wavelength is reflected on the inclined plane of the first PBS 3A. The P polarized light from the semiconductor laser element 2 for CD which has a relatively long-wavelength is transmitted through the inclined plane of the first PBS 3A, combined into the same optical path as that of the semiconductor laser element 1 for DVD, and then incident on the second PBS 4 as the originally P polarized light. Both of the laser lights from the semiconductor laser elements 1 and 2 are incident on the first PBS 3A as the P polarized lights. The first PBS 3A determines whether to transmit or reflect the laser lights depending on the wavelength thereof and brings the emitted light fluxes into the same optical path. The second PBS 4 is a polarization beam splitter which reflects or transmits an incident light depending on the polarization direction of the light. The second PBS 4 transmits a P polarized light as the P polarized light. Additionally, the reflection light from the optical disk 6 returns as an S polarized light whose polarization direction is rotated by 90 degrees. Therefore, it is possible to guide the reflection light to the light receiving element 5A with high efficiency by reflecting nearly 100 percentage of the S polarized light on the inclined plane of the second PBS 4. As a result, the conventionally-used ½ wavelength plate is not required for combining the optical paths for two wavelengths. Since the ½ wavelength plate having crystallinity is not used, it is possible to realize a more compact optical pickup device 100A capable of handling two wavelengths with a high reliability at a low cost.

In Embodiment 1, the second PBS 4 is arranged at a stage prior to the first PBS 3A in the light receiving path before the two semiconductor laser elements 1 and 2. The laser light reflected from the optical disk 6 is guided to the light receiving element 5A side after the entire components of the S polarized light is reflected once by the second PBS 4. Therefore, almost no return light returns to the first PBS 3A which is arranged closer to the semiconductor laser elements 1 and 2. Thus, there is almost no occurrence of the return light to the semiconductor laser elements 1 and 2, thereby preventing the occurrence of laser noise, which is referred to as return light noise.

Furthermore, in Embodiment 1, as shown in FIG. 1, several percentage to dozens of percentage of the laser light from the semiconductor laser element 2 for CD which has a long-wavelength is reflected on the first PBS 3A, and several percentage to dozens of percentage of the laser light from the semiconductor laser element 1 for DVD which has a short-wavelength is transmitted through the first PBS 3A. Thereafter, they are guided to the light receiving element 8 for power control. Therefore, it is possible to utilize the loss of the laser light in the first PBS 3A for power control, thereby being able to perform an efficient power distribution.

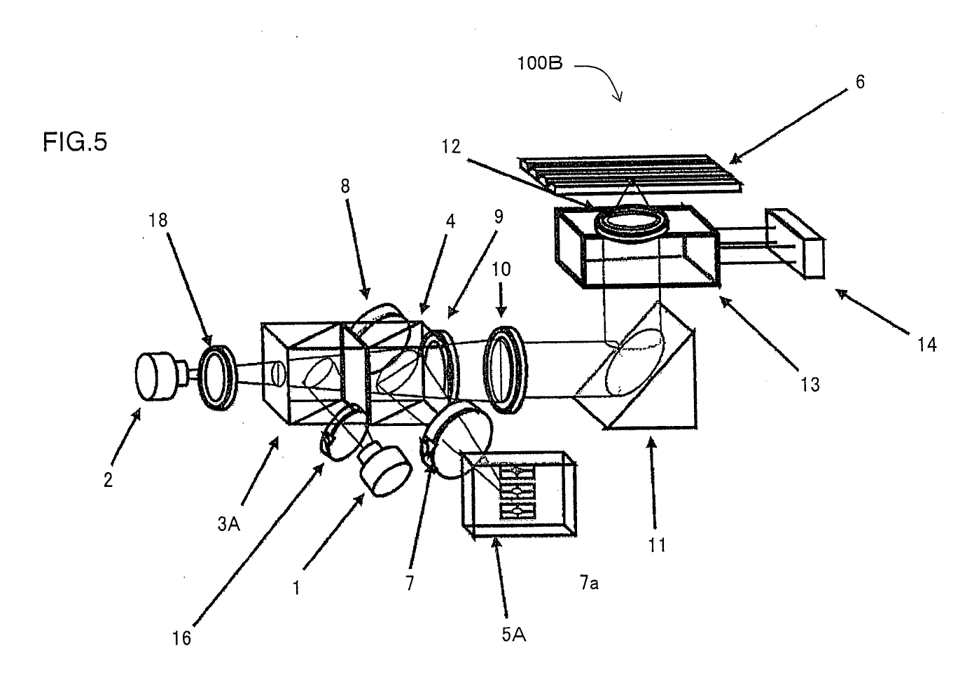

In FIG. 1, the light receiving element 8 for power control is arranged on the first PBS 3A side. However, it is possible to have the light receiving element 8 for power control is arranged on the second PBS 4 side as shown in an optical pickup device 100B capable of handling two wavelengths in FIG. 5. In this case, some of the light flux, which propagates toward the optical disk 6 emitted from the first PBS 3A, is reflected on the inclined plane of the second PBS 4 and then guided to the light receiving element 8 for power control. Since it is possible to have either structure shown in FIG. 1 or FIG. 5, the freedom of setting the reflection and transmission coefficients of the PBS which depend on the wavelengths and the polarization directions of the lights increases. Thus, it is possible to employ a low-cost PBS. The optical pickup device 100A capable of handling two wavelengths shown in FIG. 1 and the optical pickup device 100B capable of handling two wavelengths shown in FIG. 5 have the same structure except the arrangement of the light receiving element 8 for power control.

Furthermore, in Embodiment 1, since a ¼ wavelength plate 9 is attached to the optical disk 6 side which is the same side as an emission plane side of the second PBS 4, it is possible to miniaturize the optical pickup device by causing effective light flux to be small and constructing the ¼ wavelength plate 9 with a minimum amount of area. Furthermore, since the rotation error which occurs when the ¼ wavelength plate 9 is attached is prevented and the ¼ wavelength plate 9 is attached to the second PBS 4, the freedom of selecting the focusing distance of the collimate lens 10 increases, thereby being able to realize a compact optical pickup device at a low cost with a high reliability.

Furthermore, in Embodiment 1, the raise mirror 11 is provided such that the light emitted from the collimate lens 10 is vertically raised up on its way to the optical disk 6. Then, the light is incident on the objective lens 12. Owing to this structure, the freedom of selecting an optical path length of the optical pickup device increases. Thus, it is possible to select an optical path length which can avoid the laser noise. For example, when the resonator length of the semiconductor laser element is denoted as L1, the refraction index of the semiconductor laser element is denoted as N1, the air-converted optical path length of the optical pickup device is denoted as L2 and the integer is denoted as n, then two resonators are structured in the optical path length of the optical system in the semiconductor laser element and the optical pickup device at the point of
L1×N1=n×L2
Thus, the noise is increased. By making a structure in which the length of the light flux portion from the collimate lens 10 can be set freely (In the case where the optical path is not bent, the optical path is set only in accordance with the size of the length direction. However, in the case where the optical path is bent, the optical path is set in accordance with the size of the length direction and height direction, thereby expanding the freedom of selecting an optical path length of the optical pickup device), it is possible to set an optical length path to avoid the distance relationship at the point described above, thereby making this as an extremely effective section for avoiding noise and also being able to structure a thin-type optical pickup device.

Furthermore, in Embodiment 1, it is possible to prevent the out-of-focus difference between the land portion and the groove portion (shown in FIG. 15) in a special recording medium (e.g., DVD-R and DVD-RAM; shown in FIG. 13) which is capable of recording information on a land portion and a groove portion by rotation-adjusting the cylindrical lens 7 with the optical axis as its center. Furthermore, the notched portion 7a provided in the cylindrical lens 7 can facilitate the rotation-adjustment.

Furthermore, in Embodiment 1, as shown in FIG. 2, intra-connections are switched by using the switches 56a to 56d when the light receiving element 5A is adjusted and when the optical pickup device is practically operated. When the optical pickup device is practically operated, the number of output terminals is reduced by selecting the output of each of the in-phase connections 53a to 53d. Also, when the light receiving element 5A is adjusted, it is possible to clearly output the positional error between the light receiving spot H and the light receiving area (each of the four-divided areas) by selecting the output of each of the relative-connections 55a to 55d.

Furthermore, in Embodiment 1, the three-beam pitch on the light receiving element 5A is adjusted by movement-adjusting the three-beam gratings 16 and 18 in the optical axis direction and then the output balance of the relative-connections shown in FIG. 2 is adjusted so as to be uniform, thereby being able to stably operate the tracking servo.

### EMBODIMENT 2

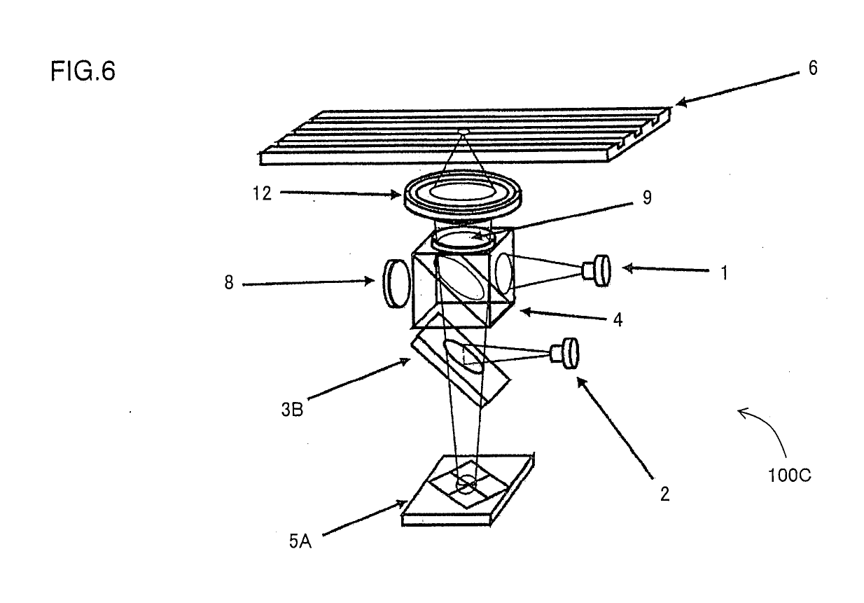

FIG. 6 is a perspective view showing a structural example of important parts of an optical pickup device capable of handling two wavelengths according to Embodiment 2 of the present invention.

In FIG. 6, the optical pickup device 100C capable of handling two wavelengths includes semiconductor laser elements 1 and 2 having different wavelengths from each other, a first PBS 3B arranged farther from an optical disk 6, a second PBS 4 arranged closer from the optical disk 6 and a light receiving element 5A for receiving a reflection light reflected from the optical disk 6. The second PBS 4 is a cube-type polarization beam splitter. As the first PBS 3B, either a cube-type polarization beam splitter or a flat-plate-type polarization beam splitter can be used. In Embodiment 2, the flat-plate-type polarization beam splitter is used as the first PBS 3B.

A laser light emitted from the semiconductor laser element 1 is incident on the second PBS 4 as an S polarized light and then reflected on the inclined plane (mirror plane) of the second PBS 4. A laser light emitted from the semiconductor laser element 2 is incident on the first PBS 3B as an S polarized light, reflected on the inclined plane (mirror plane) of the first PBS 3B and then transmitted through the inclined plane of the second PBS 4.

The reflection light which is the P polarized light from the optical disk 6 is transmitted through the inclined plane of each of the second PBS 4 and the first PBS 3B and then guided to the light receiving element 5A.

On the optical disk 6 side with respect to the second PBS 4, a ¼ wavelength plate 9 for changing the optical phase by π/4 is attached, and furthermore, an objective lens 12 is provided in order to focus the light, which is transmitted through the ¼ wavelength plate 9, on the optical disk 6. Herein, different from the case of the conventional technique in shown FIG. 10, a collimate lens 10 for collimating the light from the ¼ wavelength plate 9 and a raise mirror 11 for bending the optical path by 90 degrees are not provided.

On the side opposite to the semiconductor laser element 1 with respect to the second PBS 4, alight receiving element 8 for power control for detecting a laser power and for adjusting the output of the laser light is provided.

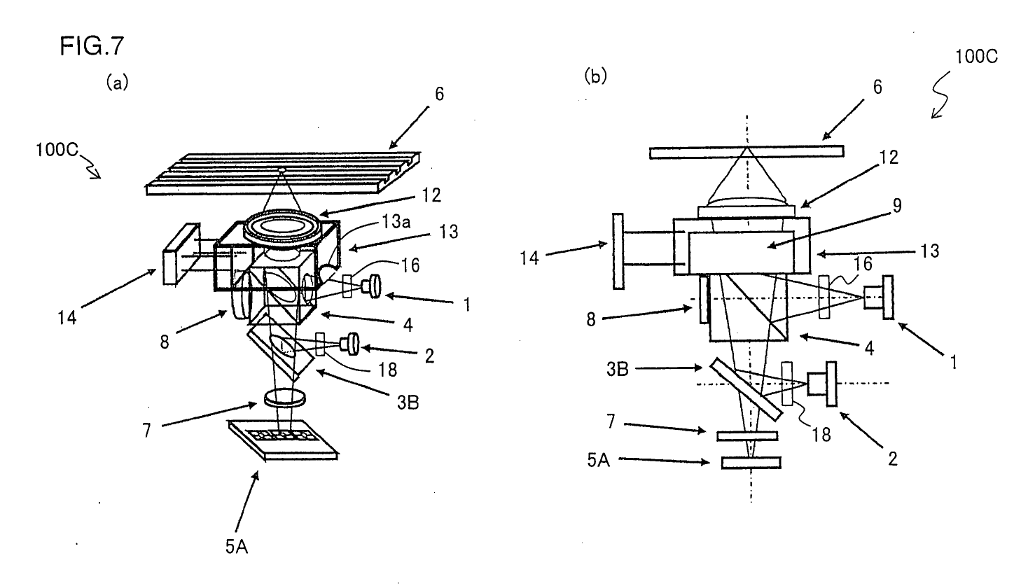

FIG. 7 is a view showing in further detail the structural example of important parts of the optical pickup device capable of handling two wavelengths shown in FIG. 6. FIG. 7(a) is a perspective view thereof. FIG. 7(b) is a longitudinal cross-sectional view thereof.

In FIG. 7, an actuator drum 13 and an actuator supporting body 14 are provided on the objective lens 12 in order to adjust the position thereof. The second PBS 4, the ¼ wavelength plate 9 and the light receiving element 8 for power control are integrated together, and a portion thereof is placed in the actuator drum 13. A semi-circular part 13a of the actuator drum 13 is taken out such that that the actuator drum 13 does not block the optical path of the laser light from the semiconductor laser element 1.

On the side opposite to the optical disk 6 with respect to the first PBS 3B, a cylindrical lens 7 is provided in order to produce astigmatism used for detecting a focus error.

Furthermore, between the second PBS 4 and the semiconductor laser element 1, a three-beam grating 16 is provided in order to form a sub-beam which is used for detecting a tracking error. Between the first PBS 3B and the semiconductor laser element 2, a three-beam grating 18 is provided in order to form a sub-beam which is used for detecting a tracking error. On the light emission side of the three-beam gratings 16 and 18, no ½ wavelength plate which is used in the conventional technique is provided. The lights from the semiconductor laser elements 1 and 2 are incident on the first PBS 3B and the second PBS 4, respectively, without propagating through the ½ wavelength plate.

Owing to the structure described above, hereinafter, the operation of the optical pickup device 100C according to Embodiment 2 will be described.

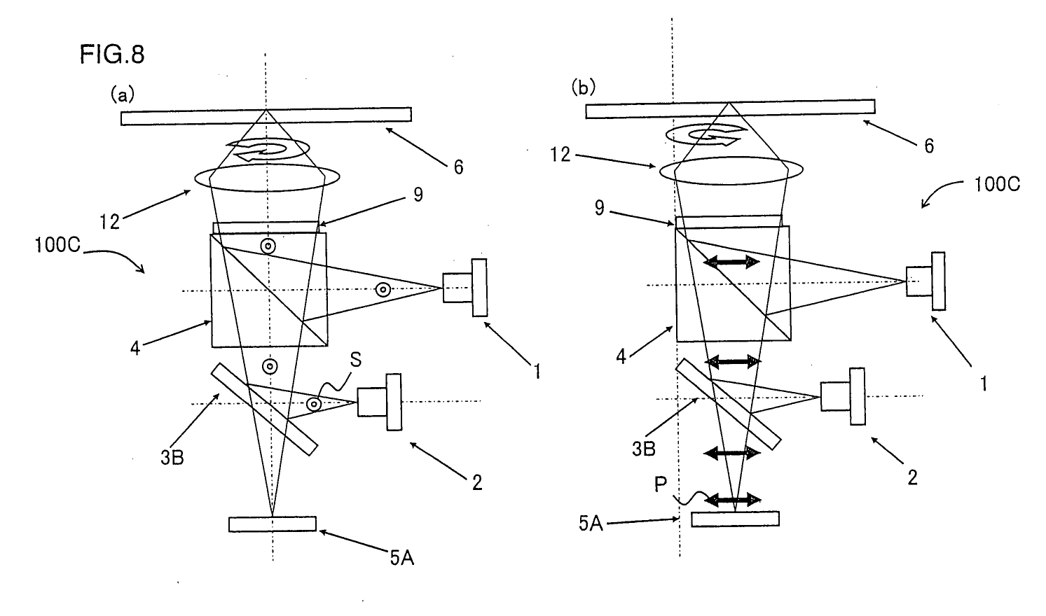

FIG. 8 is a schematic view for explaining the polarization direction of the laser light in an optical system in the optical pickup device capable of handling two wavelengths shown in FIG. 6. FIG. 8(a) is a view showing a light emission path from the semiconductor elements 1 and 2 to the optical disk 6. FIG. 8(b) is a view showing a light receiving path from the optical disk 6 to the light receiving element 5A. In FIG. 8, arrows represent the P polarized light parallel to the surface of FIG. 8, and double circles represent the S polarized light vertical to the surface of FIG. 8.

As shown in FIG. 8(a), the S polarized laser light, which is emitted from the semiconductor laser element 2, is reflected on the inclined plane of the first PBS 3B, and then transmitted through the inclined plane of the second PBS 4 as the S polarized light. Concurrently, a portion of the light is reflected on the inclined plane of the second PBS 4 and then incident on the light receiving element 8 for power control.

The S polarized laser light, which is emitted from the semiconductor laser element 1, is reflected on the inclined plane of the second PBS 4. Concurrently, a portion of the light is transmitted through the inclined plane of the second PBS 4 and then incident on the light receiving element 8 for power control.

The light flux emitted from the second PBS 4 is converted into a circularly polarized light by the ¼ wavelength plate 9. The circularly polarized light is right-handed clockwise direction with respect to its propagating direction. Then, the circularly polarized light is focused on the information recording plane of the optical disk 6 by the objective lens 12.

In FIG. 8(b), the direction of the circularly polarized light which is the reflection light reflected from the optical disk 6 is opposite to that in FIG. 8(a). This reflection light propagates through the objective lens 12 and then it is rotated into a P polarized light by the ¼ wavelength plate 9. The P polarized light is transmitted through the second PBS 4 and then transmitted through the first PBS 3B, and then incident on the light receiving element 5A.

As described above, according to the optical pickup device 100C capable of handling two wavelengths according to Embodiment 2, the S polarized light emitted from the semiconductor laser element 2 is reflected on the inclined plane of the first PBS 3B, and the S polarized light from the semiconductor laser element 1 is reflected on the inclined plane of the second PBS 4 and thus, combined into the same optical path as that of the semiconductor laser element 2. Furthermore, since the reflection light reflected from the optical disk 6 returns as a P polarized light, whose polarization direction is rotated by 90 degrees, it is possible to transmit the light through the second PBS 4 and then the first PBS 3B, both of which are polarization beam splitters, and guide it to the light receiving element 5A with high efficiency. As a result, a ½ wavelength plate is not required for combining the optical paths for two wavelengths. Since the ½ wavelength plate having crystallinity is not used, it is possible to realize the optical pickup device 100C capable of handling two wavelengths with a high reliability at a low cost.

Furthermore, in Embodiment 2, a raise mirror for bending the light flux in the optical path is not required. Thus, it is possible to construct an ultra-compact optical pickup device capable of handling two wavelengths with the minimum number of optical components. Furthermore, since the raising mirror is not provided, it is easier to perform an adjustment on the optical pickup device, thereby being able to obtain a stable characteristic of the optical pickup device.

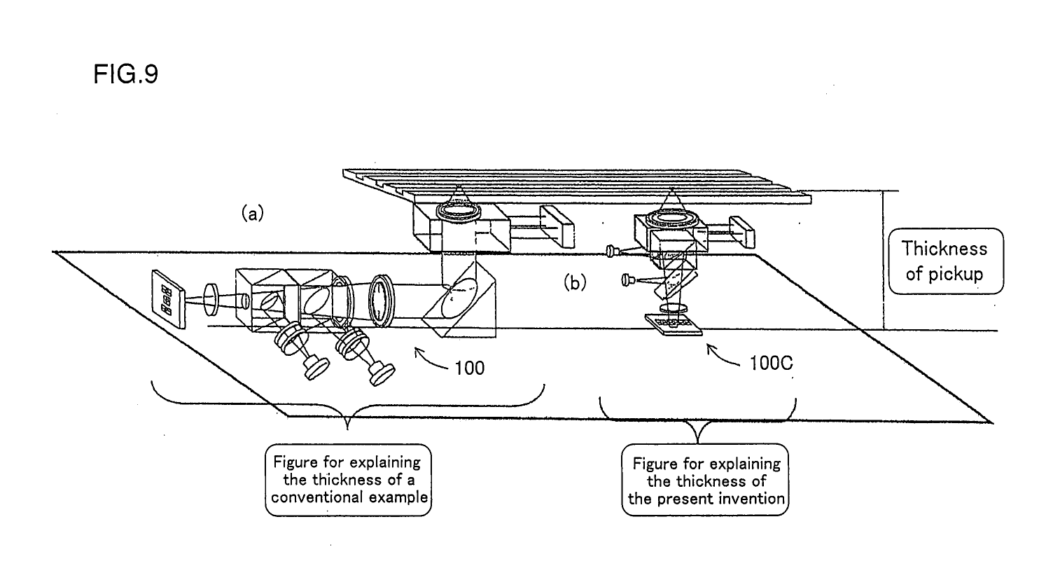

For example, as shown in FIG. 9, the optical pickup device 100C capable of handling two wavelengths according to Embodiment 2 can be structured with approximately the same thickness as that of the conventional optical pickup device 100, whose thickness is thinned by providing the raise mirror 11 in the optical path. The optical pickup device 100C capable of handling two wavelengths according to Embodiment 2 can be used as a half-height optical pickup device for DVD for writing.

Furthermore, in Embodiment 2, since a ¼ wavelength plate 9 is attached to the optical disk 6 side which is the same side as the light emission side of the second PBS 4, it is possible to cause an effective light flux to be small, thereby being able to construct the ¼ wavelength plate 9 with a minimum amount of area. Furthermore, it is possible to prevent the rotation error which occurs when the ¼ wavelength plate 9 is attached and to realize a compact optical pickup device 100C at a low cost with a high reliability.

Furthermore, in Embodiment 2, since a flat plate-type beam splitter is used as the first PBS 3B, it is possible to further thin the optical pickup device when compared to the one which uses a cube-type beam splitter.

Furthermore, in Embodiment 2, as shown in FIG. 7, the light receiving element 8 for power control is provided at a location where the laser light from the semiconductor laser element 1 is transmitted through the second PBS 4 (the light receiving element 8 for power control is provided on the side opposite to the semiconductor laser element 1 with respect to the second PBS 4). A portion of the laser light from the semiconductor laser element 1 is transmitted through the second PBS 4, and a portion of the laser light from the semiconductor laser element 2 is reflected on the inclined plane of the second PBS 4. They are guided to the light receiving element 8 side for power control. As a result, it is possible to perform a stable power control on the laser lights from the semiconductor laser elements 1 and 2, respectively.

Furthermore, in Embodiment 2, the second PBS 4, the ¼ wavelength plate 9 and the light receiving element 8 for power control are integrated together, and a portion thereof on the optical disk 6 side is placed in the actuator drum 13 of an actuator for driving an objective lens. Thus, it is possible to construct the optical path length of the optical pickup device 100C with the minimum length, thereby being able to construct a more highly densified compact optical pickup device.

Furthermore, in Embodiment 2, a semi-circular part of the actuator drum 13 is taken out such that that the actuator drum 13 does not block the optical path of the laser light from the semiconductor laser element 1. Thus, it is possible to optimally arrange the light flux so as to construct a highly densified compact optical pickup device.

Furthermore, in Embodiment 2, similar to the case in Embodiment 1 descried above, it is possible to prevent the focus difference between the land portion R and the groove G (shown in FIG. 15) in a special recording medium (e.g., DVD-R and DVD-RAM; shown in FIG. 13) which is capable of recording information on a land R and a groove G by rotation-adjusting the cylindrical lens 7 with the optical axis as its center. Furthermore, the notched portion 7a provided in the cylindrical lens 7 can facilitate the rotation-adjustment.

Furthermore, in Embodiment 2, a structure is made as shown in FIG. 2, in which the in-phase connections and the relative-connections are provided and the intra-connections can be switched between the in-phase connections and the relative-connections by using the switches 56a to 56d. Therefore, when the optical pickup device is practically operated, the number of output terminals is reduced by selecting the outputs of the in-phase connections 53a to 53d for the corresponding connections 52a to 52d and when the light receiving element 5A is adjusted, it is possible to clearly output the positional error between the light receiving spot H and the light receiving area (each of the four-divided areas) by selecting the outputs of the relative-connections 55a to 55d for the corresponding connections 52a to 52d.

Furthermore, in Embodiment 2, as in the case of Embodiment 1 described above, the three-beam pitch on the light receiving element 5A is adjusted by movement-adjusting the three-beam gratings 16 and 18 in the optical axis direction and then the output balance of the relative-connections shown in FIG. 2 is adjusted so as to be uniform, thereby being able to stably operate the tracking servo.

As described above, laser lights having wavelengths different from each other are caused to be a P polarized light or an S polarized light. The position of each of the laser elements and the position of a light receiving element are determined in accordance with the polarization direction of the emitted lights. Owing to this, it is possible to reduce the number of the components of the optical pickup device, thereby being able to miniaturize the optical pickup device.

Additionally, it is possible to improve the adjustment accuracy of the sub-beam position without increasing the number of the output terminals by providing switches for switching between (i) the outputs of the relative-connection for connecting the corresponding four-divided areas for output, which are point-symmetrical with respect to the centers of the respective sub-beam light receiving areas for detecting the tracking error and (ii) the outputs of the in-phase-connection for connecting the corresponding four-divided areas for output which have the in-phase positional relationship.

As described above, according to the optical pickup devices 100A, 100B and 100C of Embodiments 1 and 2, it is possible to miniaturize an optical pickup device by reducing the number of components and further possible to stabilize the laser noise and to optimize an optical system for handling two wavelengths. Additionally, a stable focus error signal and tracking error signal can be obtained.

In Embodiments 1 and 2 described above, the optical pickup device capable of handling two wavelengths, which is capable of handling a laser light for CD and a laser light for DVD, has been described. However, the present invention is not limited to this. The present invention is capable of handling two wavelengths of a laser light for BD and a laser light for DVD. Additionally, the laser light for CD and the laser light for DVD can be emitted, and the laser light for BD and the laser light for DVD can be simultaneously emitted or can be separately emitted from each other depending on the types of disks to be used.

Although a description has not been specifically given in Embodiments 1 and 2 described above, it is possible to construct (i) a turntable for controlling the rotation of the optical disk 6 by using the optical pickup device according to the present invention and (ii) an information recording/reproducing apparatus, which is capable of: performing a predetermined signal-processing on a signal from/to the optical pickup device according to the present invention so as to display it on a display screen on a display device; and performing a print-out from an output device, by using the optical pickup device according to the present invention.

Furthermore, although a description has not been specifically given in Embodiments 1 and 2 described above, herein, a case will be described, in which astigmatism is generated at the first PBS 3B so that a sensor lens (cylindrical-shaped lens) can be omitted. In Embodiment 2 described above, the flat-plate-type beam splitter is used as the first PBS 3B. However, the astigmatism is generated by causing the light, which is reflected on the optical disk 6 and returns therefrom, to propagate through the flat-plate-type beam splitter (first PBS 3B) arranged diagonal with respect to the optical axis. Therefore, if the flat-plate-type beam splitter is arranged diagonal with respect to the optical axis, the sensor for generating the astigmatism can be omitted.

As described above, the present invention is exemplified by the use of its preferred Embodiments 1 and 2. However, the present invention should not be interpreted solely based on Embodiments 1 and 2 described above. It is understood that the scope of the present invention should be interpreted solely based on the claims. It is also understood that those skilled in the art can implement equivalent scope of technique, based on the description of the present invention and common knowledge from the description of the detailed preferred Embodiments 1 and 2 of the present invention. Furthermore, it is understood that any patent, any patent application and any references cited in the present specification should be incorporated by reference in the present specification in the same manner as the contents are specifically described therein.

### INDUSTRIAL APPLICABILITY

According to one embodiment of the present invention, in the field of: (i) an optical pickup device including: semiconductor laser elements having two or more light source wavelengths from each other as light sources; and a light receiving element for receiving light reflected from an optical disk and (ii) an information recording/reproducing apparatus using the optical pickup device in order to handle optical disks having different specifications (e.g., DVD/CD, BD/DVD), two types of laser lights having different wavelengths from each other are incident on the first PBS, which is arranged farther from an optical disk, from different directions from each other, both of them as P polarized lights, and depending on each of the wavelengths, one of the them is transmitted through the inclined plane of the first PBS and the other is reflected on the inclined plane of the first PBS and then emitted to the same optical path, and then transmitted through the inclined plane of the second PBS, which is arranged closer to the optical disk and irradiated onto the optical disk, then an S polarized light component which is a return light from the optial disk is reflected on the inclined plane of the second PBS and guided to the light receiving element. Thus, a ½ wavelength plate, which is conventionally required in order to cause the laser lights to be incident on two PBSs, is not needed, thereby being able to miniaturize and reduce the cost of the optical pickup device. Furthermore, the amount of return light to the semiconductor laser elements is reduced and the noise occurrence is suppressed, thereby enhancing the reliability of the optical pickup device. Furthermore, by attaching the ¼ wavelength plate to the second PBS, it is possible to further miniaturize the optical pickup device.

According to another embodiment of the present invention, in an optical pickup device including: semiconductor laser elements having two or more light source wavelengths different from each other as light sources; and a light receiving element for receiving a light reflected from the optical disk in order to handle optical disks having different specifications (e.g., DVD/CD, BD/DVD), a second laser light of laser lights is incident as an S polarized light on the first PBS, which is arranged farther from the optical disk, reflected on the inclined plane of the first PBS, then transmitted through the inclined plane of the second PBS, which is arranged closer to the optical disk and irradiated onto the optical disk, and the first laser light is incident on the second PBS, reflected on the inclined plane of the second PBS and then irradiated onto the optical disk, and the S polarization component, which is a reflection light reflected from the optical disk, is transmitted through the inclined plane of each of the second PBS and the first PBS and then guided to the light receiving element. Thus, a ½ wavelength plate, which is conventionally required in order to cause the laser lights to be incident on two PBSs, is not needed, thereby being able to miniaturize and reduce the cost of the optical pickup device.

Furthermore, by rotation-adjusting the cylindrical lens with the optical axis as its center, a stable tracking error signal and focus error signal can be produced, thereby being able to enhance the reliability of the optical pickup device. Furthermore, by switching between the outputs of the in-phase connection and the outputs of the relative-phase outputs in the four-divided sub-beam light receiving areas for detecting the tracking error, it is possible to reduce the number of output terminals and to enhance the adjustment accuracy for the sub-beam position. Furthermore, by movement-adjusting the grating, which is used for generating sub-beams for detecting the tracking error, in the direction of the optical axis, it is possible to adjust the pitch error of the sub-beams.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An optical pickup device having two light sources capable of emitting lights having different wavelengths from each other for recording/reproducing information on/from an optical recording medium by using a light from the light source; wherein
the two light sources both are capable of emitting either polarization lights in one polarization direction or polarization lights crossing to the one polarization direction, and each of the two light sources is arranged at a predetermined position depending on a polarization direction of the light to be emitted.

2. An optical pickup device according to claim 1, further comprising:
a first beam splitter, arranged farther from the optical recording medium, for causing the lights having different wavelengths to be incident from different directions, for reflecting one of the lights on an inclined plane of the first beam splitter and for transmitting the other of the lights through the inclined plane of the first beam splitter so as to emit both lights in the same direction;
a second beam splitter, arranged closer to the optical recording medium, for transmitting the light from the first beam splitter through an inclined plane of the second beam splitter and irradiating the light onto the optical recording medium and for reflecting a reflection light from the optical recording medium on the inclined plane of the second beam splitter so as to emit the reflection light; and
a light receiving element for receiving an emission light from the second beam splitter.

3. An optical pickup device according to claim 1, further comprising:
a first beam splitter, arranged farther from the optical recording medium, for causing the other of the lights having different wavelengths from each other to be incident on the first beam splitter and reflecting the other of the lights on an inclined plane of the first beam splitter;
a second beam splitter, arranged closer to the optical recording medium, for transmitting the light from the first beam splitter through an inclined plane of the second beam splitter and for causing one of the lights having different wavelengths from each other to be incident on the second beam splitter and reflecting the one of the lights on the inclined plane of the second beam splitter and irradiating the light onto the optical recording medium and for transmitting a reflection light from the optical recording medium through the inclined plane of the second beam splitter; and
a light receiving element for receiving the light from the first beam splitter, the light from the second beam splitter being transmitted through the inclined plane of the first beam splitter.

4. An optical pickup device, comprising:
two light sources capable of emitting lights having different wavelengths, respectively;
a first beam splitter, arranged farther from the optical recording medium, for causing the lights having different wavelengths to be incident from different directions, for reflecting one of the lights on an inclined plane of the first beam splitter and for transmitting the other of the lights through the inclined plane of the first beam splitter and emitting the both lights in the same direction;
a second beam splitter, arranged closer to the optical recording medium, for transmitting the light from the first beam splitter through an inclined plane of the second beam splitter and irradiating the light onto the optical recording medium and for reflecting a reflection light from the optical recording medium on the inclined plane of the second beam splitter so as to emit the reflection light; and
a light receiving element for receiving an emission light from the second beam splitter.

5. An optical pickup device according to claim 2, wherein the two light sources are both semiconductor laser elements and P polarized laser lights from the semiconductor laser elements can be incident on the first beam splitter.

6. An optical pickup device according to claim 4, wherein the two light sources are both semiconductor laser elements and P polarized laser lights from the semiconductor laser elements can be incident on the first beam splitter.

7. An optical pickup device according to claim 2, further comprising: between the second beam splitter and the light receiving element,
a cylindrical lens for generating astigmatism used for detecting a focus error;
a cylindrical lens adjusting section for rotation-adjusting the cylindrical lens with the optical axis as its center.

8. An optical pickup device according to claim 4, further comprising: between the second beam splitter and the light receiving element,
a cylindrical lens for generating astigmatism used for detecting a focus error;
a cylindrical lens adjusting section for rotation-adjusting the cylindrical lens with the optical axis as its center.

9. An optical pickup device, comprising:
two light sources capable of emitting lights having different wavelengths from each other, respectively;
a first beam splitter, arranged farther from an optical recording medium, for causing the other of the lights having different wavelengths from each other to be incident on the first beam splitter and reflecting the other of the lights on an inclined plane of the first beam splitter;
a second beam splitter, arranged closer to the optical recording medium, for transmitting the light from the first beam splitter through an inclined plane of the second beam splitter and for causing one of the lights having different wavelengths from each other to be incident on the second beam splitter and reflecting the one of the lights on the inclined plane of the second beam splitter and irradiating the light onto the optical recording medium and for transmitting a reflection light from the optical recording medium through the inclined plane of the second beam splitter; and
a light receiving element for receiving the light emitted from the first beam splitter, the light from the second beam splitter being transmitted through the inclined plane of the first beam splitter.

10. An optical pickup device according to claim 3, wherein an emission light from the second beam splitter is irradiated onto the optical recording medium directly through an objective lens.

11. An optical pickup device according to claim 9, wherein an emission light from the second beam splitter is irradiated onto the optical recording medium directly through an objective lens.

12. An optical pickup device according to claim 2, wherein a ¼ wavelength plate is attached to a light emission side of the second beam splitter.

13. An optical pickup device according to claim 3, wherein a ¼ wavelength plate is attached to a light emission side of the second beam splitter.

14. An optical pickup device according to claim 4, wherein a ¼ wavelength plate is attached to a light emission side of the second beam splitter.

15. An optical pickup device according to claim 9, wherein a ¼ wavelength plate is attached to a light emission side of the second beam splitter.

16. An optical pickup device according to 3, comprising:
two four-divided sub-beam light receiving areas for detecting a tracking error in the light receiving element, wherein
the optical pickup device is capable of connecting outputs of the front inner circumferential sides, outputs of the rear inner circumferential sides, outputs of the front outer circumferential sides and outputs of the rear outer circumferential sides of a forward sub-beam and a rearward sub-beam and of producing an output, wherein the outputs of the respective sides have the same in-phase positional relationship.

17. An optical pickup device according to 4, comprising:
two four-divided sub-beam light receiving areas for detecting a tracking error in the light receiving element, wherein
the optical pickup device is capable of connecting outputs of the front inner circumferential sides, outputs of the rear inner circumferential sides, outputs of the front outer circumferential sides and outputs of the rear outer circumferential sides of a forward sub-beam and a rearward sub-beam and of producing an output, wherein the outputs of the respective sides have the same in-phase positional relationship.

18. An optical pickup device according to 9, comprising:
two four-divided sub-beam light receiving areas for detecting a tracking error in the light receiving element, wherein
the optical pickup device is capable of connecting outputs of the front inner circumferential sides, outputs of the rear inner circumferential sides, outputs of the front outer circumferential sides and outputs of the rear outer circumferential sides of a forward sub-beam and a rearward sub-beam and of producing an output, wherein the outputs of the respective sides have the same in-phase positional relationship.

19. An information recording/reproducing apparatus for recording/reproducing information on/from the optical recording medium by using the optical pickup device according to claim 1.

20. An information recording/reproducing apparatus for recording/reproducing information on/from the optical recording medium by using the optical pickup device according to claim 4.

21. An information recording/reproducing apparatus for recording/reproducing information on/from the optical recording medium by using the optical pickup device according to claim 9.
